(19) United States
(12) Patent Application Publication
(10) Pub. No.: US 2024/0397488 A1
(43) Pub. Date: Nov. 28, 2024

(54) COMMUNICATION SCHEDULING IN FRAME

(71) Applicant: QUALCOMM Incorporated, San Diego, CA (US)

(72) Inventors: Ahmed Ragab ELSHERIF, San Jose, CA (US); Raja BANERJEA, Saratoga, CA (US); Kenneth Marvin GAINEY, Escondido, CA (US); Rong HE, San Diego, CA (US)

(21) Appl. No.: 18/321,695

(22) Filed: May 22, 2023

(51) Int. Cl. H04W 72/0446; H04W 72/1263; H04W 74/00; H04W 74/04

(52) U.S. Cl. CPC H04W 72/0446; H04W 72/1263; H04W 74/006; H04W 74/04; A63F 13/235

(57) ABSTRACT

Various aspects of the present disclosure generally relate to wireless communication. In some aspects, a central device may transmit an indication that a first peripheral device is to, within each frame rendered by the central device, receive downlink data from the central device in a downlink slot and transmit available uplink data to the central device within one or more first service periods that are assigned to the first peripheral device in an uplink slot. The central device may transmit, based at least in part on the indication, a downlink message in a downlink slot of a frame. The central device may receive, based at least in part on the indication, a first uplink message in a first service period assigned to the first peripheral device in an uplink slot of the frame. Numerous other aspects are described.

### FIELD OF THE DISCLOSURE

Aspects of the present disclosure generally relate to wireless communication and to techniques and apparatuses associated with scheduling communications for a central device and peripheral devices in frames rendered by the central device.

### BACKGROUND

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

A wireless personal area network (WPAN) is a short-range wireless network typically established by a user to interconnect various personal devices, sensors, and/or appliances located within a certain distance or area of the user. For example, a WPAN based on a communication protocol such as a Bluetooth® (BT) protocol, a Bluetooth Low Energy (BLE) protocol, or a Zigbee® protocol may provide wireless connectivity to peripheral devices that are within a specific distance (e.g., 5 meters, 10 meters, 20 meters, 100 meters) of each other. Bluetooth is a short-range wireless communication protocol that supports a WPAN between a central device (such as a host device or a source device) and at least one peripheral device (such as a client device or a sink device). However, power consumption associated with Bluetooth communications that operate on a basic rate (BR) and/or enhanced data rate (EDR) physical layer may render WPAN communication impractical in certain applications.

Accordingly, to address the power consumption challenges associated with Bluetooth BR/EDR (sometimes referred to as a Bluetooth classic or Bluetooth legacy protocol), BLE (also referred to herein as WPAN LE) was developed and adopted in various applications in which data transfers are relatively infrequent and/or to enable WPAN communication with low power consumption. For example, BLE exploits infrequent data transfer by using a low duty cycle operation and placing one or both of the central device and the peripheral device(s) into a sleep mode between data transmissions, thereby conserving power. Example applications that use BLE include battery-operated sensors and actuators in various medical, industrial, consumer, and fitness applications. BLE may also be used to connect devices such as BLE-enabled smartphones, tablets, laptops, earbuds, or the like. While traditional (or classic) Bluetooth and BLE offer certain advantages, there exists a need for further improvements in Bluetooth and BLE technology. For example, traditional Bluetooth and BLE have a limited range, have a limited data throughput, and are susceptible to interference from other devices communicating in the same frequency band (such as via WLAN communications).

### SUMMARY

Some aspects described herein relate to a method of wireless communication performed by a central device. The method may include transmitting an indication that a first peripheral device is to, within each frame rendered by the central device, receive downlink data from the central device in a downlink slot and transmit available uplink data to the central device within one or more first service periods that are assigned to the first peripheral device in an uplink slot. The method may include transmitting, based at least in part on the indication, a downlink message in a downlink slot of a frame. The method may include receiving, based at least in part on the indication, a first uplink message in a first service period assigned to the first peripheral device in an uplink slot of the frame.

Some aspects described herein relate to a method of wireless communication performed by a first peripheral device. The method may include receiving an indication that the first peripheral device is to, within each frame rendered by a central device, receive downlink data from the central device in a downlink slot and transmit available uplink data to the central device within one or more first service periods that are assigned to the first peripheral device in an uplink slot. The method may include receiving, based at least in part on the indication, a downlink message in a downlink slot of a frame. The method may include transmitting, based at least in part on the indication, a first uplink message in a first service period assigned to the first peripheral device in an uplink slot of the frame.

Some aspects described herein relate to a central device for wireless communication. The central device may include one or more memories and one or more processors coupled to the one or more memories. The one or more processors may be individually or collectively configured to transmit an indication that a first peripheral device is to, within each frame rendered by the central device, receive downlink data from the central device in a downlink slot and transmit available uplink data to the central device within one or more first service periods that are assigned to the first peripheral device in an uplink slot. The one or more processors may be individually or collectively configured to transmit, based at least in part on the indication, a downlink message in a downlink slot of a frame. The one or more processors may be individually or collectively configured to receive, based at least in part on the indication, a first uplink message in a first service period assigned to the first peripheral device in an uplink slot of the frame.

Some aspects described herein relate to a first peripheral device for wireless communication. The first peripheral device may include one or more memories and one or more processors coupled to the one or more memories. The one or more processors may be individually or collectively configured to receive an indication that the first peripheral device is to, within each frame rendered by a central device, receive downlink data from the central device in a downlink slot and transmit available uplink data to the central device within one or more first service periods that are assigned to the first peripheral device in an uplink slot. The one or more processors may be individually or collectively configured to receive, based at least in part on the indication, a downlink message in a downlink slot of a frame. The one or more processors may be individually or collectively configured to transmit, based at least in part on the indication, a first uplink message in a first service period assigned to the first peripheral device in an uplink slot of the frame.

Some aspects described herein relate to a non-transitory computer-readable medium that stores a set of instructions for wireless communication by a central device. The set of instructions, when executed by one or more processors of the central device, may cause the central device to transmit an indication that a first peripheral device is to, within each frame rendered by the central device, receive downlink data from the central device in a downlink slot and transmit available uplink data to the central device within one or more first service periods that are assigned to the first peripheral device in an uplink slot. The set of instructions, when executed by one or more processors of the central device, may cause the central device to transmit, based at least in part on the indication, a downlink message in a downlink slot of a frame. The set of instructions, when executed by one or more processors of the central device, may cause the central device to receive, based at least in part on the indication, a first uplink message in a first service period assigned to the first peripheral device in an uplink slot of the frame.

Some aspects described herein relate to a non-transitory computer-readable medium that stores a set of instructions for wireless communication by a first peripheral device. The set of instructions, when executed by one or more processors of the first peripheral device, may cause the first peripheral device to receive an indication that the first peripheral device is to, within each frame rendered by a central device, receive downlink data from the central device in a downlink slot and transmit available uplink data to the central device within one or more first service periods that are assigned to the first peripheral device in an uplink slot. The set of instructions, when executed by one or more processors of the first peripheral device, may cause the first peripheral device to receive, based at least in part on the indication, a downlink message in a downlink slot of a frame. The set of instructions, when executed by one or more processors of the first peripheral device, may cause the first peripheral device to transmit, based at least in part on the indication, a first uplink message in a first service period assigned to the first peripheral device in an uplink slot of the frame.

Some aspects described herein relate to an apparatus for wireless communication. The apparatus may include means for transmitting an indication that a first peripheral device is to, within each frame rendered by the apparatus, receive downlink data from the apparatus in a downlink slot and transmit available uplink data to the apparatus within one or more first service periods that are assigned to the first peripheral device in an uplink slot. The apparatus may include means for transmitting, based at least in part on the indication, a downlink message in a downlink slot of a frame. The apparatus may include means for receiving, based at least in part on the indication, a first uplink message in a first service period assigned to the first peripheral device in an uplink slot of the frame.

Some aspects described herein relate to an apparatus for wireless communication. The apparatus may include means for receiving an indication that the apparatus is to, within each frame rendered by another apparatus, receive downlink data from the other apparatus in a downlink slot and transmit available uplink data to the other apparatus within one or more first service periods that are assigned to the first peripheral device in an uplink slot. The apparatus may include means for receiving, based at least in part on the indication, a downlink message in a downlink slot of a frame. The apparatus may include means for transmitting, based at least in part on the indication, a first uplink message in a first service period assigned to the first peripheral device in an uplink slot of the frame.

Aspects generally include a method, apparatus, system, computer program product, non-transitory computer-readable medium, user equipment, base station, network entity, network node, central device, peripheral device, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features May include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless personal area network (WPAN), in accordance with the present disclosure.

FIG. 2 is a diagram illustrating an example of a wireless communication device, in accordance with the present disclosure.

FIG. 3 is a diagram illustrating an example of a protocol stack, in accordance with the present disclosure.

FIG. 4 is a diagram illustrating an example transmission of a data packet from a wireless communication device to a peripheral device over a WPAN connection, in accordance with the present disclosure.

FIG. 5 is a diagram illustrating an example of a wireless communication device, in accordance with the present disclosure.

FIG. 6 is a diagram illustrating an example of a gaming system, in accordance with the present disclosure.

FIG. 7 is a diagram illustrating an example of Wi-Fi communication, in accordance with the present disclosure.

FIG. 8 shows another example physical protocol data unit usable for wireless communication between a wireless access point and one or more wireless stations, in accordance with the present disclosure.

FIG. 9 is a diagram illustrating an example of a scheduling hierarchy, in accordance with the present disclosure.

FIG. 10 is a diagram illustrating an example of indicating a scheduling hierarchy, in accordance with the present disclosure.

FIG. 11 is a diagram illustrating examples of traffic patterns for a single controller, in accordance with the present disclosure.

FIG. 12 is a diagram illustrating an example of traffic patterns for multiple controllers, in accordance with the present disclosure.

FIG. 13 is a diagram illustrating an example of traffic patterns for multiple controllers, in accordance with the present disclosure.

FIG. 14 is a diagram illustrating an example of traffic patterns for multiple controllers, in accordance with the present disclosure.

FIG. 15 is a diagram illustrating examples of access schemes, in accordance with the present disclosure.

FIG. 16 is a diagram illustrating an example of an access scheme, in accordance with the present disclosure.

FIG. 17 is a diagram illustrating an example of vendor specific content, in accordance with the present disclosure.

FIG. 18 is a diagram illustrating an example process performed, for example, by a central device, in accordance with the present disclosure.

FIG. 19 is a diagram illustrating an example process performed, for example, by a first peripheral device, in accordance with the present disclosure.

FIG. 20 is a diagram of an example apparatus for wireless communication, in accordance with the present disclosure.

FIG. 21 is a diagram of an example apparatus for wireless communication, in accordance with the present disclosure.

### DETAILED DESCRIPTION

In a wireless personal area network (WPAN), such as a Bluetooth (BT) network or a Bluetooth Low Energy (BLE) network, wireless audio may stream from a central source device (e.g., a handset, a gaming console) to multiple peripheral devices (e.g., gaming controllers). Wi-Fi features of an access point (AP) in a wireless local area network (WLAN) may also be used for communications in the WPAN.

According to various aspects described herein, a central device (e.g., an AP, a WPAN scheduler, a gaming console for a gaming application) may indicate a flexible scheduling architecture to peripheral devices (e.g., gaming controllers for the application). The scheduling architecture may include a hierarchical design that splits communications during a rendered video frame of an application into a downlink slot and an uplink slot. Downlink data, such as haptics data, voice data, and/or audio data, can be transmitted during the downlink slot. A graphics engine may run at the beginning of the frame and use the downlink data to create the image of the rendered frame. The console may collect uplink data that can be used to render the next frame. Controllers may transmit the uplink data during an uplink slot of the same frame. The uplink slot may be split into multiple uplink service periods (SPs). Each controller may be assigned one or more SPs. Uplink data transmitted in the SPs may include control and/or voice data.

By using a scheduling architecture that schedules downlink data during a downlink slot and uplink data during SPs assigned to peripheral devices (e.g., gaming controllers), a central device (e.g., a gaming console) may ensure that the controllers share uplink access in a way that can avoid collisions and provide for a more even distribution of uplink access during a video frame rendered for an application. In this way, the controllers have better timing and performance for users than if there was no scheduled uplink access for the controllers during a frame.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

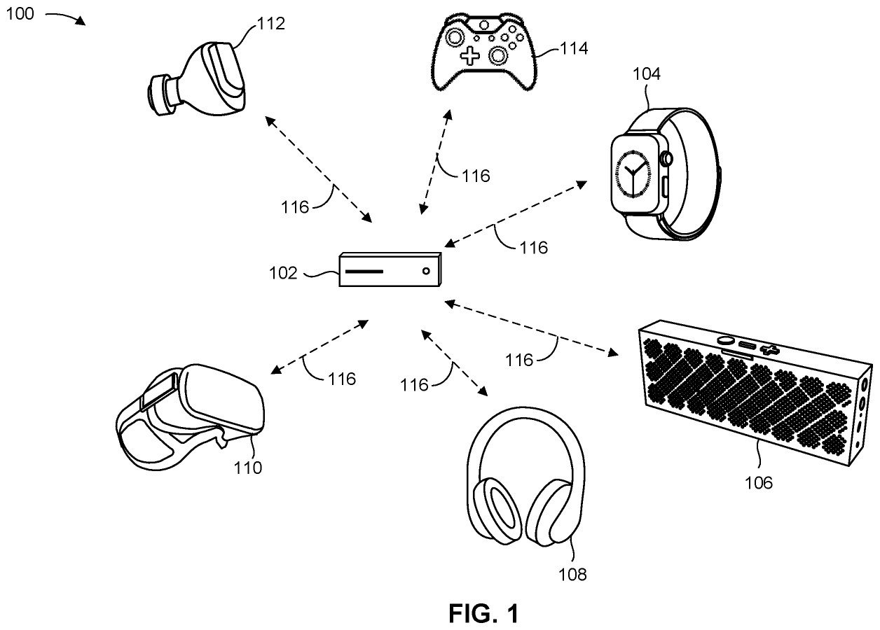

FIG. 1 is a diagram illustrating an example of a WPAN 100, according to some implementations. Within the WPAN 100, a central device 102 (which may be referred to herein as a source device or using other suitable terminology), such as a gaming console, may connect to and may establish a communication link 116 with one or more peripheral devices, such as a smartwatch 104, a portable speaker 106, wireless headphones 108, a head-mounted device (HMD) or extended (XR) reality headset 110, a wireless earbud 112, a wireless game controller 114 (which may be referred to herein as sink devices or using other suitable terminology) using a BLE protocol or a modified BLE protocol. The BLE protocol is part of the BT core specification and enables radio frequency communication operating within the globally accepted 2.4 GHz Industrial, Scientific, and Medical (ISM) band.

In some aspects, as described herein, the central device 102 may include suitable logic, circuitry, interfaces, processors, and/or code that may be used to communicate with the one or more peripheral devices 104, 106, 108, 110, 112, and/or 114 using the BLE protocol or the modified BLE protocol. In some aspects, the central device 102 may operate as an initiator to request establishment of a link layer (LL) connection with an intended peripheral device 104, 106, 108, 110, 112, and/or 114. In some aspects, a link manager may be used to control operations between a WPAN application controller in the central device 102 and a WPAN application controller in each of the intended peripheral devices 104, 106, 108, 110, 112, and/or 114.

In some aspects, after a requested LL connection is established, the central device 102 may become a host device, and the selected or intended peripheral device 104, 106, 108, 110, 112, and/or 114 may become paired with the central device 102 over the established LL connection. As a host device, the central device 102 may support multiple concurrent LL connections with various peripheral devices 104, 106, 108, 110, 112, and/or 114 that are operating as client devices. For example, the central device 102 may manage various aspects of data packet communication in an LL connection with one or more associated peripheral devices 104, 106, 108, 110, 112, and/or 114. For example, the central device 102 may determine an operation schedule in the LL connection with one or more peripheral devices 104, 106, 108, 110, 112, and/or 114. The central device 102 may also initiate an LL protocol data unit (PDU) exchange sequence over the LL connection. LL connections may be configured to run periodic connection events in dedicated data channels. The exchange of LL data PDU transmissions between the central device 102 and one or more of the peripheral devices 104, 106, 108, 110, 112, and/or 114 may take place within connection events.

In some aspects, the central device 102 may be configured to transmit the first LL data PDU in each connection event to an intended peripheral device 104, 106, 108, 110, 112, and/or 114. Additionally, or alternatively, in some aspects, the central device 102 may utilize a polling scheme to poll the intended peripheral device 104, 106, 108, 110, 112, and/or 114 for an LL data PDU transmission during a connection event. The intended peripheral device 104, 106, 108, 110, 112, and/or 114 may transmit an LL data PDU upon receipt of a packet carrying an LL data PDU from the central device 102. In some other aspects, a peripheral device 104, 106, 108, 110, 112, and/or 114 may transmit an LL data PDU to the central device 102 without first receiving an LL data PDU from the central device 102.

Examples of the central device 102 may include a cellular phone, a smartphone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player, a camera, a game console, a tablet, a smart device, a wearable device (such as a smart watch or wireless headphones), a vehicle, a vehicle infotainment system or car kit, an electric meter, a gas pump, a toaster, a thermostat, a hearing aid, a blood glucose on-body unit, an Internet-of-Things (IoT) device, or the like.

Examples of the one or more peripheral devices 104, 106, 108, 110, 112, and/or 114 may include a cellular phone, a smartphone, an SIP phone, an STA, a laptop, a PC, a desktop computer, a PDA, a satellite radio, a global positioning system, a multimedia device, a video device, a digital audio player, a camera, a game console, a tablet, a smart device, a wearable device (e.g., a smart watch, wireless headphones, or wireless earbuds), a vehicle, a vehicle infotainment system or car kit, an electric meter, a gas pump, a toaster, a thermostat, a hearing aid, a blood glucose on-body unit, an IoT device, or the like. Although the central device 102 is illustrated in FIG. 1 as being in communication with six peripheral devices 104, 106, 108, 110, 112, and 114 in the WPAN 100, it will be appreciated that the central device 102 may communicate with more or fewer than six peripheral devices within the WPAN 100 without departing from the scope of the present disclosure.

In some aspects, a device implementing the BT protocol (e.g., the central device 102) may operate according to a first radio mode (e.g., a basic rate (BR)/enhanced data rate (EDR) radio mode), and a device implementing the BLE protocol may operate according to a second radio mode (e.g., the BLE radio mode). In some aspects, the central device 102 may be configured with dual radio modes, and therefore may be able to operate according to the BR/EDR mode or the BLE mode, for example, based on the type of short-range wireless communication in which the central device 102 may engage. In some aspects, the central device 102 may operate using Wi-Fi links.

For example, in some aspects, the central device 102 may operate according to the BR/EDR mode or Wi-Fi mode for continuous streaming of data, for broadcast networks, for mesh networks, and/or for some other applications in which a relatively higher data rate may be more suitable. Additionally, or alternatively, the central device 102 may operate according to the BLE mode or Wi-Fi mode for short burst data transmissions, such as for some other applications in which power conservation may be desirable and/or a relatively lower data rate may be acceptable. Additionally, or alternatively, in some aspects, the central device 102 may operate according to one or more other radio modes, such as proprietary radio mode(s). Examples of other radio modes may include high speed radio modes, low energy radio modes, and/or isochronous radio modes, among other examples.

In some aspects, as described in more detail elsewhere herein, an assisting wireless device (e.g., among peripheral devices 104, 106, 108, 110, 112, and 114) may track a first retransmission metric that is based on a number of retransmitted packets that the assisting wireless device received from a source device, such as the central device 102. The assisting wireless device may receive, from a sink wireless device (e.g., among peripheral devices 104, 106, 108, 110, 112, and 114), an acknowledgement assistance request indicating a second retransmission metric for the sink wireless device. The assisting wireless device may transmit, to the sink wireless device, a response to the acknowledgement assistance request based on respective values of the first retransmission metric and the second retransmission metric. Additionally, or alternatively, the assisting wireless device may perform one or more other operations described herein.

In some aspects, as described in more detail elsewhere herein, a sink wireless device (e.g., among peripheral devices 104, 106, 108, 110, 112, and 114) may track a first retransmission metric that is based on a number of retransmitted packets that the sink wireless device received from a source device, such as the central device 102. The sink wireless device may transmit, to an assisting wireless device (e.g., among peripheral devices 104, 106, 108, 110, 112, and 114), an acknowledgement assistance request indicating the first retransmission metric tracked by the sink wireless device. The sink wireless device may receive, from the assisting wireless device, a response to the acknowledgement assistance request based on respective values of the first retransmission metric tracked by the sink wireless device and a second retransmission metric tracked by the assisting wireless device. Additionally, or alternatively, the sink wireless device may perform one or more other operations described herein.

As indicated above, FIG. 1 is provided as an example. Other examples may differ from what is described with regard to FIG. 1.

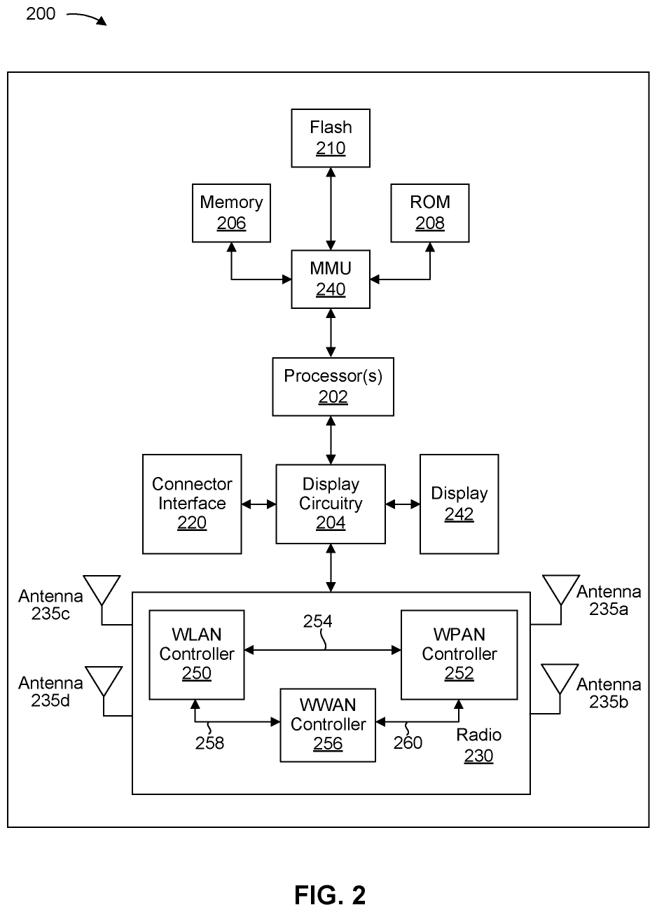

FIG. 2 is a diagram illustrating an example of a wireless communication device 200, in accordance with the present disclosure. In some aspects, the wireless communication device 200 may be an example of the central device 102 illustrated in FIG. 1. Additionally, or alternatively, the wireless communication device 200 may be an example of one or more of the peripheral devices 104, 106, 108, 110, 112, or 114 illustrated in FIG. 1. In some aspects, the wireless communication device 200 may be a Bluetooth-enabled device (such as a BLE device) or an AP.

As shown in FIG. 2, the wireless communication device 200 may include a processing element, such as processor(s) 202, which may execute program instructions for the wireless communication device 200. The wireless communication device 200 may also include a display 242 that can perform graphics processing and present information to a user. The processor(s) 202 may also be coupled to a memory management unit (MMU) 240, which may be configured to receive addresses from the processor(s) 202 and translate the addresses to address locations in memory such as memory 206, ROM 208, or flash memory 210 and/or to address locations in other circuits or devices, such as display circuitry 204, radio 230, connector interface 220, and/or display 242. The MMU 240 may also be configured to perform memory protection and page table translation or set up. In some aspects, the MMU 240 may be included as a portion of the processor(s) 202.

The processor(s) 202 may be coupled to other circuits of the wireless communication device 200. For example, the wireless communication device 200 may include various memory types, a connector interface 220 through which the wireless communication device 200 can communicate with a computer system, and wireless communication subsystems that can transmit data to, and receive data from, other devices based on one or more wireless communication standards or protocols. For example, in some aspects, the wireless communication subsystems may include (but are not limited to) a wireless local-area network (WLAN) subsystem, a WPAN subsystem, and/or a cellular subsystem (such as a Long-Term Evolution (LTE) or New Radio (NR) subsystem). The wireless communication device 200 may include multiple antennas 235a. 235b, 235c, and/or 235d for performing wireless communication with, for example, wireless communication devices in a WPAN. In some aspects, the WPAN may be an extended PAN (XPAN).

The wireless communication device 200 may be configured to implement part or all of the techniques described herein by executing program instructions stored on a memory medium (such as a non-transitory computer-readable memory medium) and/or through hardware or firmware operation. In other embodiments, the techniques described herein may be at least partially implemented by a programmable hardware element, such as an FPGA, and/or an application specific integrated circuit (ASIC).

In some aspects, the radio 230 may include separate controllers configured to control communications for various respective radio access technology (RAT) protocols. For example, as shown in FIG. 2, radio 230 may include a WLAN controller 250 that manages WLAN communications, a WPAN controller 252 that manages Bluetooth, BLE, and/or other suitable WPAN communications, and a wireless wide area network (WWAN) controller 256 that manages WWAN communications. In some aspects, the wireless communication device 200 may store and execute a WLAN software driver for controlling WLAN operations performed by the WLAN controller 250, a WPAN software driver for controlling WPAN operations performed by the WPAN controller 252, and/or a WWAN software driver for controlling WWAN operations performed by the WWAN controller 256.

In some aspects, a first coexistence interface 254 (such as a wired interface) may be used for sending information between the WLAN controller 250 and the WPAN controller 252. Additionally, or alternatively, in some aspects, a second coexistence interface 258 may be used for sending information between the WLAN controller 250 and the WWAN controller 256. Additionally, or alternatively, in some aspects, a third coexistence interface 260 may be used for sending information between the WPAN controller 252 and the WWAN controller 256.

In some aspects, one or more of the WLAN controller 250, the WPAN controller 252, and/or the WWAN controller 256 may be implemented as hardware, software, firmware, or any suitable combination thereof.

In some aspects, the WLAN controller 250 may be configured to communicate with a second device in a WPAN using a WLAN link using one or more, some, or all of the antennas 235a, 235b, 235c, and 235d. In other configurations, the WPAN controller 252 may be configured to communicate with at least one second device in a WPAN using one or more, some, or all of the antennas 235a, 235b, 235c, and 235d. In other configurations, the WWAN controller 256 may be configured to communicate with a second device in a WPAN using one or more, some, or all of the antennas 235a, 235b, 235c, and 235d. The WLAN controller 250, the WPAN controller 252, and/or the WWAN controller 256 may be configured to adjust a wakeup time interval and a shutdown time for the wireless communication device 200.

A short-range wireless communications protocol, such as BT, BLE, and/or BR/EDR, may include and/or may use one or more other communications protocols, for example, to establish and maintain communications links. Referring also to FIG. 1, the wireless communication device 200 may establish a communications link 116 with one or more peripheral devices, such as a wireless headset 112, according to at least one communications protocol for short-range wireless communications. In some aspects, the communications link 116 may include a communications link that adheres to a protocol included and/or for use with BT, BLE, BR/EDR, or the like. In one aspect, the communications link 116 may include an asynchronous connection-oriented logical (ACL) transport, sometimes referred to as an ACL link. When operating as an ACL link, the communications link 116 may allow the central device 102 (e.g., a source device) to connect or “pair” with a peripheral device, such as the headset 112. The connection is asynchronous in that the two devices may not need to synchronize, timewise, data communications between each other to permit communication of data packets via the communications link 116.

In some aspects, a logical link control and adaptation protocol (L2CAP) may be used within a BT protocol stack (not shown in FIG. 2 for simplicity). An L2CAP connection may be established after an ACL link has been established. Reference to L2CAP in the present disclosure may be further applicable to enhanced L2CAP (EL2CAP), which may be an enhanced version of the L2CAP protocol that enables multiplexing of multiple logical data channels via a single radio connection.

In some aspects, the communications link 116 may include an advanced audio distribution profile (A2DP) link. For example, an A2DP link may provide a point-to-point link between a source device, such as the central device 102, and a sink device, such as the headset 112. With an A2DP link, data packets including audio may be transmitted over an ACL channel, and other information (e.g., for controlling the audio stream) may be transmitted over a separate control channel. The data packets may occur non-periodically.

In some aspects, the communications link 116 may support synchronous logical transport mechanisms between a source device (such as the central device 102) and a peripheral device (such as the headset 112). For example, the communications link 116 may include a synchronous connection-oriented (SCO) link that provides a symmetric point-to-point link between the source device and the peripheral device using time slots reserved for BT communications. In some aspects, an SCO link may not support retransmission of data packets, which may be unsatisfactory in audio streaming and/or voice call use cases in which a dropped audio or voice packet may reduce the quality of the user experience.

In some aspects, the communications link 116 may include an extended SCO (eSCO) link. An eSCO link may provide a symmetric or asymmetric point-to-point link between a source device and a peripheral device using time slots reserved for BT communications, and may also provide for a retransmission window following the reserved time slots. Because retransmissions may be facilitated using the retransmission window, an eSCO link may be suitable for audio streaming and/or voice call use cases because a dropped audio or voice packet may be retransmitted, and therefore the probability of successfully receiving a data packet may be increased.

In some aspects, the communications link 116 shown in FIG. 1 may include an isochronous (ISO) link. When operating as an ISO link, the communications link 116 may combine some features of both synchronous and asynchronous links. For example, a stream on an ISO link may begin with a start packet, and then data packets may be asynchronously transmitted. On an ISO link, the number of retransmission attempts by a transmitting device may be limited. Thus, if a receiving device is unable to decode a data packet within the limited number of retransmission attempts, then the data packet may be dropped, and the receiving device may continue to receive the stream without data from the dropped data packet.

In some aspects, a central device (e.g., wireless communication device 200) includes means for transmitting an indication that a first peripheral device is to, within each frame rendered by the central device, receive downlink data from the central device in a downlink slot and transmit available uplink data to the central device within one or more first service periods that are assigned to the first peripheral device in an uplink slot; means for transmitting, based at least in part on the indication, a downlink message in a downlink slot of a frame; and/or means for receiving, based at least in part on the indication, a first uplink message in a first service period assigned to the first peripheral device in an uplink slot of the frame. In some aspects, the means for the central device to perform operations described herein may include, for example, one or more of antennas 235a-235d, WPAN controller 252, radio 230, and/or processor 202, among other examples.

In some aspects, a first peripheral device (e.g., wireless communication device 200) includes means for receiving an indication that the first peripheral device is to, within each frame rendered by a central device, receive downlink data from the central device in a downlink slot and transmit available uplink data to the central device within one or more first service periods that are assigned to the first peripheral device in an uplink slot; means for receiving, based at least in part on the indication, a downlink message in a downlink slot of a frame; and/or means for transmitting, based at least in part on the indication, a first uplink message in a first service period assigned to the first peripheral device in an uplink slot of the frame. In some aspects, the means for the first peripheral device to perform operations described herein may include, for example, one or more of antennas 235a-235d, WPAN controller 252, radio 230, and/or processor 202, among other examples.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

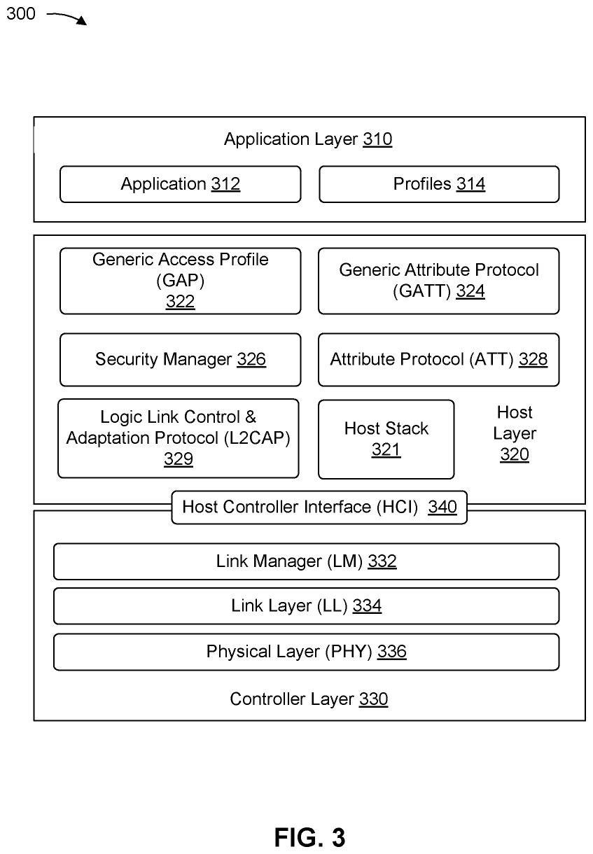

FIG. 3 is a diagram illustrating an example 300 of a protocol stack (e.g., a WPAN and/or a Bluetooth protocol stack), in accordance with the present disclosure. In some aspects, the protocol stack 300 may be implemented in a wireless communication device (such as the central device 102 or one or more of the peripheral devices 104, 106, 108, 110, 112, or 114 of FIG. 1). For example, the protocol stack 300 may be implemented by one or more of processor(s) 202, memory 206, flash memory 210. ROM 208, the radio 230, and/or the WPAN controller 252 illustrated in FIG. 2. In some aspects, the protocol stack 300 may be organized into three layers that include an application layer 310, a host layer 320, and a controller layer 330.

In some aspects, the application layer 310 may be a user application layer that interfaces with the other blocks and/or layers of the protocol stack 300. In some aspects, the application layer 310 may include one or more applications 312 and one or more Bluetooth profiles 314 that allow the one or more applications 312 to use Bluetooth and/or BLE communications. The host layer 320 may include the upper layers of the protocol stack 300, and may communicate with a controller (such as the WPAN controller 252 of FIG. 2) in a wireless communication device using a host controller interface (HCI) 340. In some aspects, the host layer 320 may include a host stack 321 that can be used for application layer interface management to allow an application 312 to access WPAN communications.

The controller layer 330 may include the lower layers of the protocol stack 300. In some aspects, the controller layer 330 may be used for hardware interface management, link establishment, and link management. As shown in FIG. 3, the controller layer 330 may include a link manager (LM) 332, a link layer 334, and a physical (PHY) layer 336. The PHY layer 336 may include, for example, a radio and/or a baseband processor. In some aspects, the PHY layer 336 may define a mechanism for transmitting a bit stream over a physical link or channel that connects WPAN devices. The bit stream may be grouped into code words or symbols, and may be converted to a data packet that is transmitted over a wireless transmission medium. The PHY layer 336 may provide an electrical, mechanical, and/or procedural interface to the wireless transmission medium. The PHY layer 336 may be responsible for modulation and demodulation of data into radio frequency (RF) signals for transmission over the air. The PHY layer 336 may describe the physical characteristics of a transmitter/receiver (or transceiver) included in a wireless communication device. The physical characteristics may include modulation characteristics, an RF tolerance, and/or a sensitivity level, among other examples.

In some aspects, the link layer 334 is responsible for low-level communication over the PHY layer 336. The link layer 334 may manage the sequence and timing for transmitting and receiving data packets, and using an LL protocol, communicates with other devices regarding connection parameters and data flow control. The link layer 334 also provides gatekeeping functionality to limit exposure and data exchange with other devices. If filtering is configured, the link layer 334 maintains a list of allowed devices and may ignore all requests for data exchange from devices not on the list of allowed devices. The link layer 334 may also reduce power consumption. In some aspects, the link layer 334 may include a proprietary LL that may be used to discover peer devices, and establish a secure communication channel with the peer devices. In some aspects, the link layer 334 may be responsible for transporting data packets between devices in a WPAN. Each data packet may include an access address, which specifies the type of logical transport used to carry the data packet. Logical transports may exist between a master device and slave devices. Additionally, some logical transports may carry multiple logical links.

The link manager 332 may be responsible for establishing and configuring links and managing power-change requests, among other tasks. Each type of logical link, such as ACL links, A2DP links, SCO links, eSCO links, ISO links, or the like, may be associated with a specific packet type. For example, an SCO link may provide reserved channel bandwidth for communication between a central device and a peripheral device, and may support regular, periodic exchange of data packets with no retransmissions. An eSCO link may provide reserved channel bandwidth for communication between a source device and a peripheral device, and support regular, periodic exchange of data packets with retransmissions. An ACL link may exist between a source device and a peripheral device from the beginning of establishment of a connection between the source device and the peripheral device, and the data packets for ACL links may include encoding information in addition to a payload.

The link manager 332 may communicate with the host layer 320 using the HCI 340. In some aspects, the link manager 332 may translate commands associated with the HCI 340 into controller-level operations, such as baseband-level operations. The HCI 340 may act as a boundary between the lower layers (such as between the controller layer 330, the host layer 320, and the application layer 310). The BT specification may define a standard HCI to support BT systems that are implemented across two separate processors. For example, a BT system on a computer may use a processor of the BT system to implement the lower layers of the protocol stack 300, such as the PHY layer 336, the link layer 334, and/or the link manager 332, and may use a processor of a BT component to implement the other layers of the protocol stack 300, such as the host layer 320 and the application layer 310.

In FIG. 3, the host layer 320 is shown to include a generic access profile (GAP) 322, a generic attribute protocol (GATT) 324, a security manager (SM) 326, an attribute protocol (ATT) 328, and an L2CAP layer 329. The GAP 322 may provide an interface for an application 312 to initiate, establish, and manage connections with other WPAN (e.g., BT or BLE) devices. The GATT 324 may provide a service framework using the attribute protocol for discovering services, and for reading and writing characteristic values on a peer device. The GATT 324 may interface with the application 312, for example, through a profile which may define a collection of attributes and any permissions needed for the attributes to be used in BT or BLE communications.

The security manager 326 may be responsible for device pairing and key distribution. A security manager protocol implemented by the security manager 326 may define how communications with the security manager of a counterpart BLE device are performed. The security manager 326 provides additional cryptographic functions that may be used by other components of the protocol stack 300. The architecture of the security manager 326 used in WPAN communications is designed to minimize recourse requirements for peripheral devices by shifting work to a presumably more powerful central device. BLE uses a pairing mechanism for key distribution. The security manager 326 provides a mechanism to encrypt the data and a mechanism to provide data authentication.

The ATT 328 includes a client/server protocol based on attributes associated with a BLE device configured for a particular purpose. Examples may include monitoring heart rate, temperature, broadcasting advertisements, or the like. The attributes may be discovered, read, and written by peer devices. The set of operations which are executed over the ATT 328 may include error handling, server configuration, find information, read operations, write operations, and/or queued writes. The ATT 328 may form the basis of data exchange between BT and BLE devices.

The L2CAP layer 329 may be implemented above the HCI 340, and may communicate with the controller layer 330 through the HCI 340. The L2CAP layer 329 may be responsible for establishing connections across one or more existing logical links and for requesting additional links if none exist. The L2CAP layer 329 may also implement multiplexing between different higher-layer protocols, for example, to allow different applications to use a single link, such as a logical link, including an ACL link. In some implementations, the L2CAP layer 329 may encapsulate multiple protocols from the upper layers into a data packet format (and vice versa). The L2CAP layer 329 may also break packets with a large data payload from the upper layers into multiple packets with the data payload segmented into smaller size data payloads that fit into a maximum payload size (for example, twenty-seven (27) bytes) on the transmit side.

In some standards and protocols, such as BLE and/or BR/EDR, the central device 102 may detect errors in a packet and/or a dropped/missed/not received packet through the use of cyclic redundancy check (CRC) validation and through the use of message integrity code (MIC) validation. MIC validation may be used when a packet is encrypted. For example, failure of CRC validation may indicate one or more errors in a received packet, and failure of MIC validation may indicate that another packet has not been received (although failure of CRC validation may also indicate that another packet has not been received, and/or failure of MIC validation may also indicate one or more errors in a received packet).

CRC validation and MIC validation may be based on generating CRC values and MICs, respectively, based on received packets and respectively comparing those generated CRC values and MICs to CRC values and MICs included in the received packets. Specifically, a receiving device, such as the headset 112, that receives a packet may first generate a CRC value or a CRC checksum based on the received packet, such as based on a payload and, if applicable, an MIC included in the received packet. The receiving device may compare the generated CRC value with a CRC value included in the received packet. If the generated CRC value matches the CRC value included in the received packet, then the received packet may be validated for CRC. The CRC-validated received packet may then be decrypted. However, if the generated CRC value does not match the CRC value included in the received packet, then the receiving device may determine that the received packet fails CRC validation. If the receiving device determines that the received packet fails CRC validation, then the received packet may include errors and/or may be corrupted. In one configuration, the receiving device may discard the received packet that fails CRC validation. Alternatively, in another configuration, the receiving device may attempt to recover the received packet, for example, using one or more error correction techniques.

If the received packet is encrypted and passes CRC validation, then the receiving device may decrypt the received packet to obtain a decrypted payload and a decrypted MIC. For MIC validation, the receiving device may generate an MIC based on the decrypted payload, and compare the generated MIC with the MIC obtained from the decrypted received packet. If the generated MIC matches the decrypted MIC, then the receiving device may determine that the received packet is successfully decrypted. When the received packet is successfully decrypted, the decoded and decrypted payload of the received packet may be provided to another layer of the receiving device, such as a coder-decoder (codec) of the receiving device that may cause the payload data of the received packet to be output by the receiving device, for example, as audio through speakers of the headset 112.

If the generated MIC does not match the decrypted MIC of the received packet, then the receiving device may determine that the received packet is unsuccessfully decrypted. When the received packet is unsuccessfully decrypted, then a different packet may have been missed or the received packet may be erroneous or otherwise corrupted. In one configuration, the receiving device may discard the received packet that fails MIC validation. Alternatively, in another configuration, the receiving device may attempt to recover the received packet.

As indicated above, FIG. 3 is provided as an example. Other examples may differ from what is described with regard to FIG. 3.

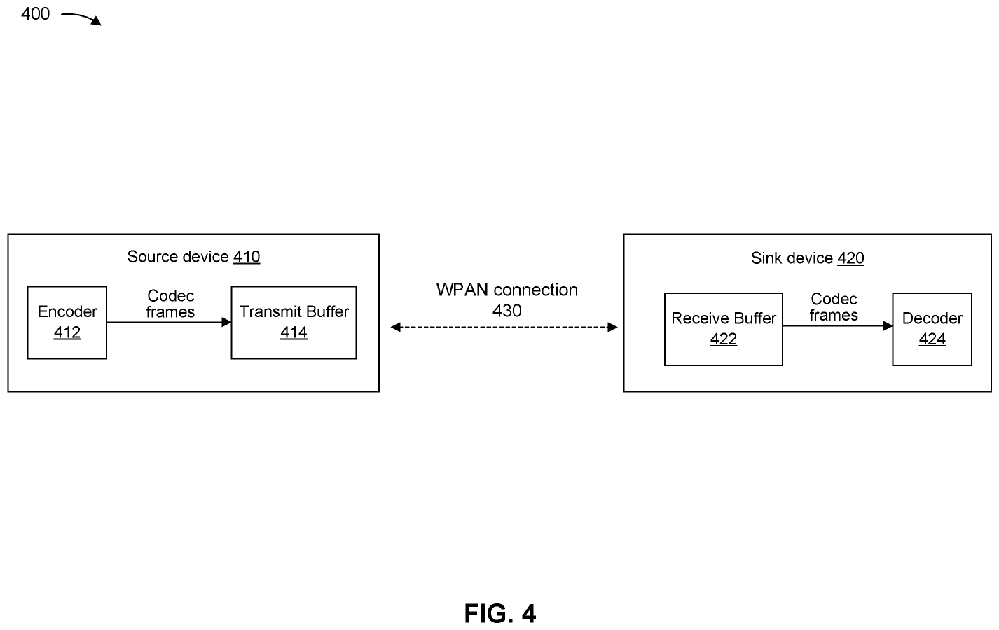

FIG. 4 is a diagram illustrating an example transmission 400 of a data packet from a source device 410 to a sink device 420 over a WPAN connection 430, according to the present disclosure. In some aspects, the source device 410 may be one example of the central device 102 in FIG. 1 and/or the wireless communication device 200 in FIG. 2, and the sink device 420 may be an example of one or more of the peripheral devices 104, 106, 108, 110, 112 or 114 in FIG. 1. In some aspects, the sink device 420 may be a wireless earbud, a pair of wireless earbuds, a wireless portable speaker, or another suitable device. The WPAN connection 430 may be any suitable Bluetooth or BLE connection or link. In some instances, the WPAN connection 430 may be one or more of an ACL link, an L2CAP link, an A2DP link, an SCO link, or an ISO link.

As shown in FIG. 4, the source device 410 may include an encoder 412 and a transmit buffer 414. The encoder 412 may be configured to encode data, such as audio or video data, using a specified bitrate. The transmit buffer 414 may be configured to queue data packets that are to be transmitted over the WPAN connection 430 to the sink device 420. In some implementations, the data packets to be transmitted over the WPAN connection 430 may have a predefined size, for example, based on the type of WPAN connection 430 and/or channel conditions associated with the WPAN connection 430. In some aspects, data encoded by the encoder 412 may be packetized into a data packet of a predefined size. The source device 410 may de-queue data packets from the transmit buffer 414 and transmit the data packets to the sink device 420 over the WPAN connection 430.

As further shown in FIG. 4, the sink device 420 may include a receive buffer 422 and a decoder 424. Data packets that the sink device 420 receives over the WPAN connection 430 may be queued or otherwise stored in the receive buffer 422. The data packets may be output from the receive buffer 422 and forwarded to the decoder 424. In some aspects, the decoder 424 may decode data (such as audio and/or video data) carried in the payloads of the queued data packets, and forward the decoded data to upper layers of the protocol stack for processing and playback to a user. In some implementations, the encoder 412 may encode a first encoder/decoder (codec) frame using a first bitrate and forward the first codec frame to the transmit buffer 414 to be packetized for transmission to the sink device 420 over the WPAN connection 430. The sink device 420 may queue the received data packet in the receive buffer 422 and may forward the first portion of the first codec frame to the decoder 424 for decoding.

As indicated above, FIG. 4 is provided as an example. Other examples may differ from what is described with regard to FIG. 4.

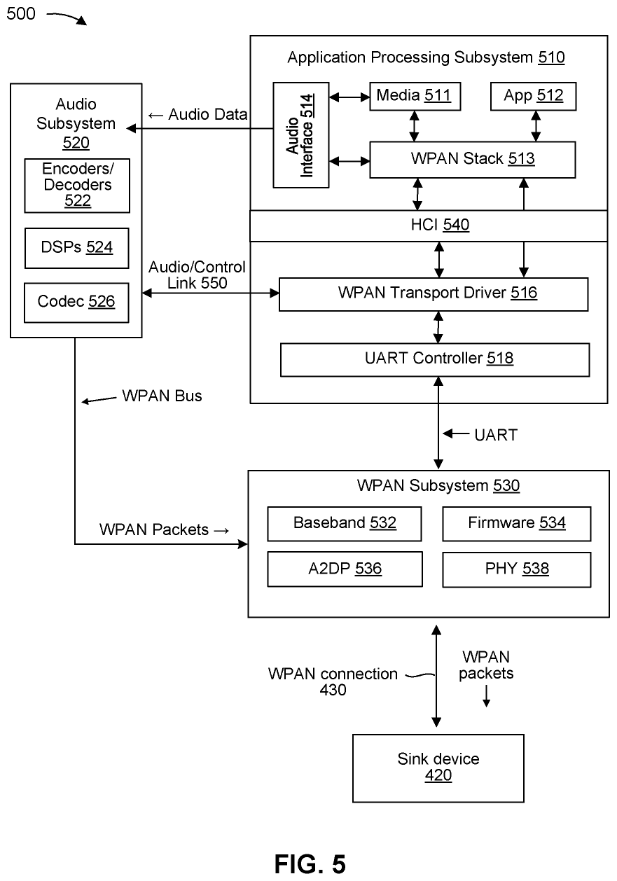

FIG. 5 is a diagram illustrating an example 500 of a wireless communication device 500, according to the present disclosure. In some aspects, the wireless communication device 500 may be an example of the central device 102 in FIG. 1, the wireless communication device 200 in FIG. 2, or the source device 410 in FIG. 4. In example 500, the wireless communication device 500 is depicted as having an established WPAN connection 430 (e.g., a Bluetooth communication connection) with the sink device 420 in FIG. 4.

The wireless communication device 500 may include an application processing subsystem 510, an audio subsystem 520, a WPAN subsystem 530, and an HCI 540. The application processing subsystem 510, which may correspond to at least some portions of the application layer 310 and the host layer 320 of the protocol stack 300 of FIG. 3, is shown to include a media player 511, an application layer 512, a WPAN stack 513, and an audio interface 514. The media player 511 can be any suitable device or component capable of generating or receiving multimedia content including, for example, real-time audio streams, real-time video streams, real-time gaming streams, and/or latency-sensitive traffic, among other examples. The application layer 512, which may be one implementation of the application layer 310 of FIG. 3, includes at least one Bluetooth profile that defines the collection of attributes and associated permissions to be used in Bluetooth or BLE communications. In some aspects, the application layer 512 may include processing resources including, for example, the memory 206, the ROM 208, and/or the flash memory 210 of FIG. 2. The WPAN stack 513 may be one implementation of the protocol stack 300 of FIG. 3.

In some aspects, as shown in FIG. 5, the application processing subsystem 510 may include a WPAN transport driver 516, which may include a split audio and packetization module (not shown for simplicity) that can packetize data (such as audio and/or video data) into Bluetooth frames that can be transmitted to the sink device 420 using a Bluetooth and/or BLE protocol. In some aspects, the WPAN transport driver 516 may be connected to the audio subsystem 520 via an audio and control link 550. In some aspects, the audio and control link 550 may be used to send encoded audio/video data and control signals between the WPAN transport driver 516 and audio/video DSPs within the audio subsystem 520. The WPAN transport driver 516 is also connected to a universal asynchronous receiver-transmitter (UART) controller 518 that provides controls for transmission of information via the WPAN connection 430.

The audio subsystem 520 may include encoders/decoders 522, one or more DSPs 524, and one or more codecs 526. The encoders/decoders 522 may be used to sample audio/video data extracted from one or more packets received from another wireless communication device. The extracted audio/video data may be processed in the application processing subsystem 510 based at least in part on the Bluetooth profile. In some implementations, the encoders/decoders 522 may partition the sampled audio/video data into payloads that can be embedded within one or more Bluetooth packets for transmission to the sink device 420 over the WPAN connection 430. In some instances, the DSPs 524 and/or the codecs 526 may employ one or more encoding or decoding algorithms in conjunction with sampling the audio data.

The WPAN subsystem 530 may include a baseband component 532 (e.g., a Bluetooth baseband component), a firmware component 534, an A2DP component 536, and a PHY component 538. The baseband component 532 and the firmware component 534 may be used to generate baseband signals for constructing and deconstructing data frames based on the Bluetooth or BLE protocol. The baseband component 532 and the firmware component 534 may also be used to generate carrier signals for up-converting baseband signals during data transmissions and for down-converting received data signals to baseband. The A2DP component 536 may be used to control or manage an A2DP link between the wireless communication device 500 and the sink device 420. Specifically, when the WPAN subsystem 530 is in a receive mode, the PHY component 538 can be used to receive, demodulate, and down-convert data packets received over the WPAN connection 430, and to forward the data packets to the application processing subsystem 510. When the WPAN subsystem 530 is in a transmit mode, the PHY component 538 can be used to encapsulate data provided from the upper layers into one or more Bluetooth frames or packets for transmission to the sink device 420 over the WPAN connection 430.

As indicated above, FIG. 5 is provided as an example. Other examples may differ from what is described with regard to FIG. 5.

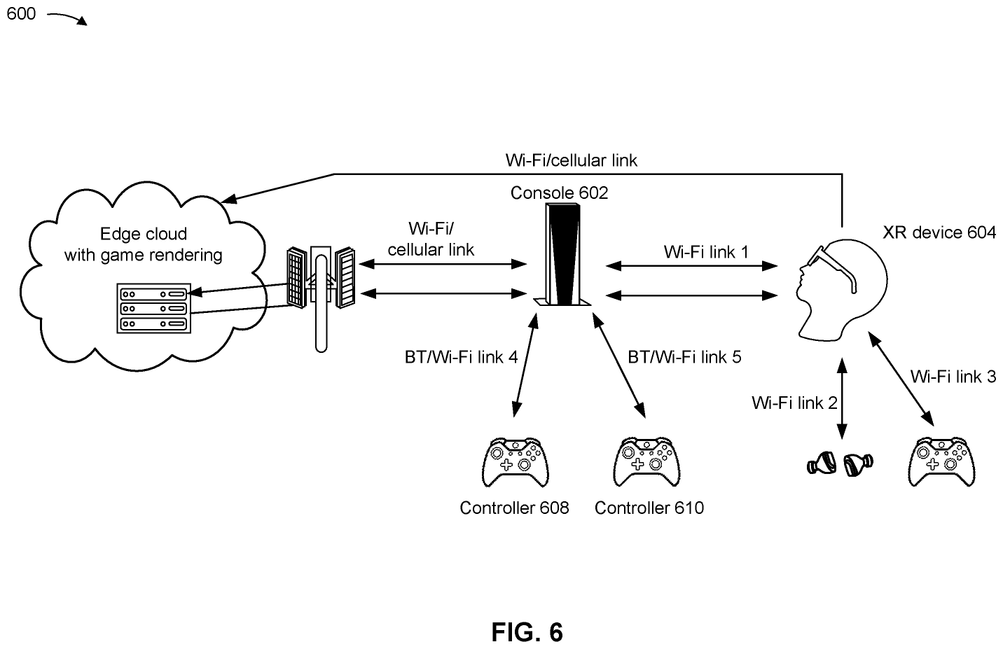

FIG. 6 is a diagram illustrating an example 600 of a gaming system, in accordance with the present disclosure.

A gaming system may include a central device, such as a gaming console 602 or an XR device 604 (e.g., HMD, XR glass). The central device may communicate with a gaming server or an edge cloud on the other side of a network entity (e.g., gNB). The edge server may split computations with the central device.

The central device may render video frames of a gaming application and communicate with peripheral devices, such as controller 608 and controller 610. The central device may transmit data to the peripheral devices in broadcast, multicast, or sequential unicast packets. The central device may transmit data and receive data from peripheral devices over a Bluetooth link or a Wi-Fi link. Example 600 shows different links that may be used for communication, such as Wi-Fi/cellular links, Wi-Fi link 1 between the console 602 and the XR device 604, Wi-Fi link 2 between the XR device 604 and some earbuds, Wi-Fi link 3 between the XR device 604 and a controller, Bluetooth (BT)/Wi-Fi link 4 between the console 602 and controller 608, and a BT/Wi-Fi link 5 between the console 602 and controller 610.

When console gaming or XR gaming is involved, there are timing issues. With a frame rate of 120 frames per second (fps), the end-to-end delay is expected to be 8.33 milliseconds (ms). With a typical host stack delay (controller software stack delay) of 2 ms and a console/glass processing budget (console software stack delay) of 2 ms, this allows for 2 ms of over-the-air latency (wireless medium delay). A clean channel (not used by other devices) in 5 GHZ/6 GHz and ANI networks can reduce the impact of interference. However, multiple simultaneous controllers need to be supported (up to 4) and there can be some access issues.

Controller access may involve a target wake time (TWT) protocol, a random access protocol, or some type of proprietary channel access scheme. A TWT protocol is used in Wi-Fi to conserve battery power and to avoid uplink access contention. An AP may schedule TWT time durations during which a STA is awake and/or has uplink access to the wireless network. The STA is otherwise asleep and/or does not have uplink access to the network. TWT may avoid uplink access contention by scheduling different STAs to wake up and/or transmit at different times. A random access protocol may include sensing the channel and, if the channel is not clear, backing off or waiting to sense again after a random amount of time.

As indicated above, FIG. 6 is provided as an example. Other examples may differ from what is described with regard to FIG. 6.

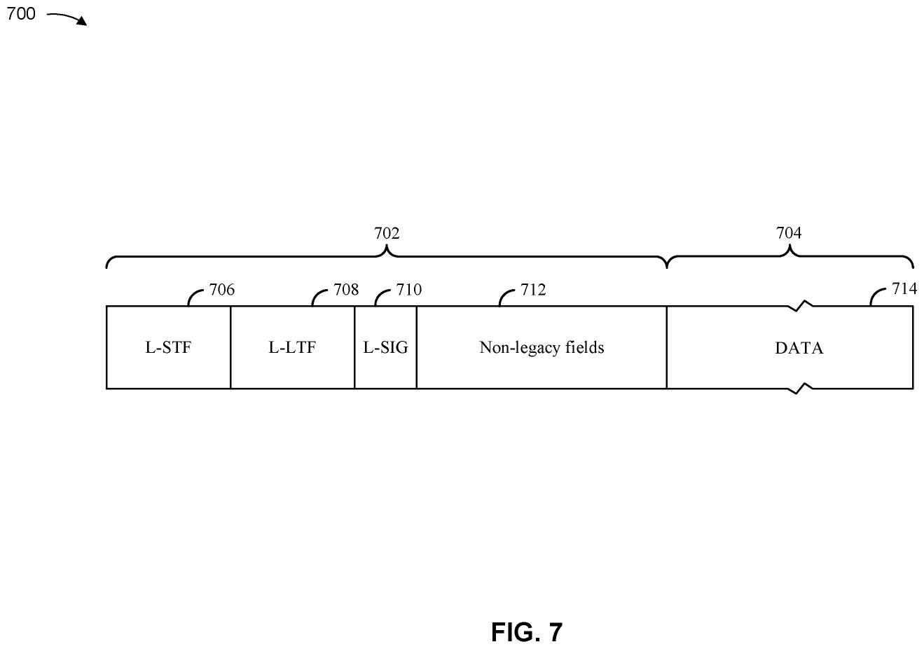

FIG. 7 is a diagram illustrating an example 700 of Wi-Fi communication, in accordance with the present disclosure.

In some aspects, the central device and the peripheral devices may communicate using Wi-Fi, such as by implementing at least one of the Institute of Electrical and Electronic Engineers (IEEE) 802.11 family of wireless communication protocol standards (such as that defined by the IEEE 802.11-2020 specification or amendments thereof including, but not limited to, 802.11ay, 802.11ax, 802.11az, 802.11ba. 802.11bd, 802.11be, 802.11bf, and the 802.11 amendment associated with Wi-Fi 8). The central device may operate as a wireless AP (e.g., using WLAN controller 250) and the peripheral devices may operate as STAs. Each of the STAs also may be referred to as a mobile station (MS), a mobile device, a mobile handset, a wireless handset, an access terminal, a user equipment (UE), a subscriber station (SS), or a subscriber unit, among other examples. The STAs may represent various devices such as mobile phones, personal digital assistant (PDAs), other handheld devices, netbooks, notebook computers, tablet computers, laptops, chromebooks, XR headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs in the network are able to communicate with one another via the AP.

A single AP (e.g., console 602) and an associated set of STAs (e.g., controller 608, controller 610) may be referred to as a basic service set (BSS), which is managed by the respective AP. The AP may cover a basic service area (BSA). The BSS may be identified or indicated to users by a service set identifier (SSID), as well as to other devices by a basic service set identifier (BSSID), which may be a medium access control (MAC) address of the AP. The AP may periodically broadcast beacon frames (“beacons”) including the BSSID to enable any STAs within wireless range of the AP to “associate” or re-associate with the AP to establish a respective communication link (hereinafter also referred to as a “Wi-Fi link”), or to maintain a communication link, with the AP. For example, the beacons can include an identification or indication of a primary channel used by the respective AP as well as a timing synchronization function for establishing or maintaining timing synchronization with the AP. The AP may provide access to external networks to various STAs in the WLAN via respective communication links.

The AP and STAs may function and communicate (via the respective communication links) according to one or more of the IEEE 802.11 family of wireless communication protocol standards. These standards define the WLAN radio and baseband protocols for the PHY and MAC layers. The AP and STAs transmit and receive wireless communications (hereinafter also referred to as “Wi-Fi communications” or “wireless packets”) to and from one another in the form of PHY protocol data units (PPDUs). The APs and STAs may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the AP and STAs described herein also may communicate in other frequency bands, such as the 5.9 GHz and the 6 GHz bands, which may support both licensed and unlicensed communications. The AP and STAs also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHZ, 5 GHZ or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

FIG. 7 shows an example PDU 700 usable for wireless communication between a wireless AP and one or more wireless STAs. For example, the PDU 700 can be configured as a PPDU. As shown, the PDU 700 includes a PHY preamble 702 and a PHY payload 704. For example, the preamble 702 may include a legacy portion that itself includes a legacy short training field (L-STF) 706, which may consist of two symbols, a legacy long training field (L-LTF) 708, which may consist of two symbols, and a legacy signal field (L-SIG) 710, which may consist of two symbols. The legacy portion of the preamble 702 may be configured according to the IEEE 802.11a wireless communication protocol standard. The preamble 702 also may include a non-legacy portion including one or more non-legacy fields 712, for example, conforming to one or more of the IEEE 802.11 family of wireless communication protocol standards.

The L-STF 706 generally enables a receiving device to perform coarse timing and frequency tracking and automatic gain control (AGC). The L-LTF 708 generally enables a receiving device to perform fine timing and frequency tracking and also to perform an initial estimate of the wireless channel. The L-SIG 710 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 706, the L-LTF 708 and the L-SIG 710, may be modulated according to a binary phase shift keying (BPSK) modulation scheme. The payload 704 may be modulated according to a BPSK modulation scheme, a quadrature BPSK (Q-BPSK) modulation scheme, a quadrature amplitude modulation (QAM) modulation scheme, or another appropriate modulation scheme. The payload 704 may include a PSDU including a data field (DATA) 714 that, in turn, may carry higher layer data, for example, in the form of MAC protocol data units (MPDUs) or an aggregated MPDU (A-MPDU).

As indicated above, FIG. 7 is provided as an example. Other examples may differ from what is described with regard to FIG. 7.

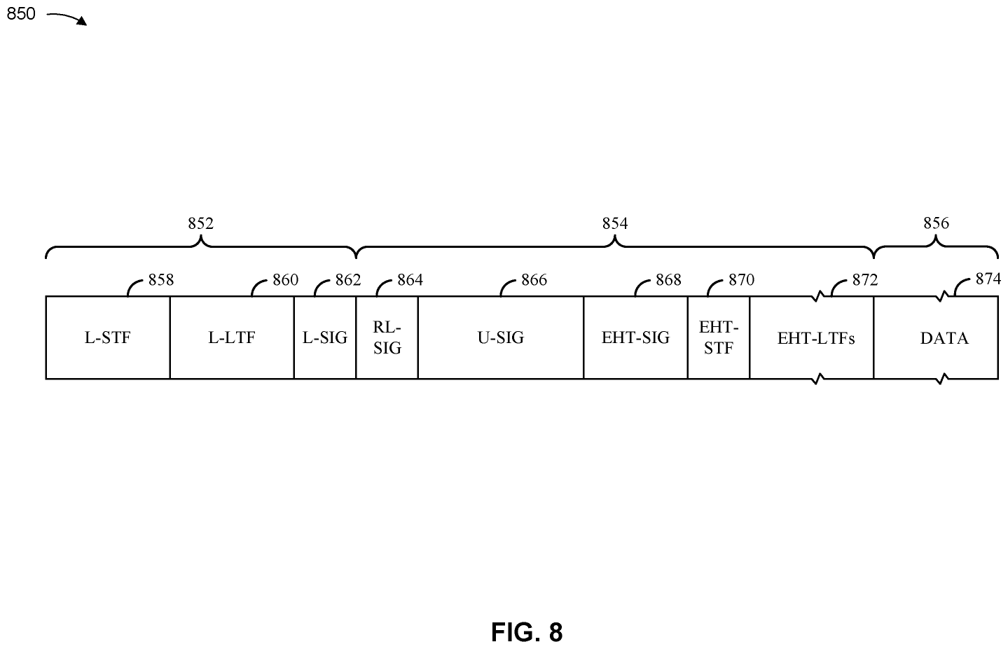

FIG. 8 shows an example PPDU 850 usable for wireless communication between a wireless AP and one or more wireless STAs, in accordance with the present disclosure.

The PPDU 850 may be used for single user orthogonal frequency-division multiple access (OFDMA) or multi-user multiple-input multiple-output (MU-MIMO) transmissions. The PPDU 850 may be formatted as an Extremely High Throughput (EHT) WLAN PPDU in accordance with the IEEE 802.11be amendment to the IEEE 802.11 family of wireless communication protocol standards, or may be formatted as a PPDU conforming to any later (post-EHT) version of a new wireless communication protocol conforming to a future IEEE 802.11 wireless communication protocol standard, such as the 802.11 amendment associated with Wi-Fi 8), or another wireless communication standard. The PPDU 850 includes a PHY preamble including a legacy portion 852 and a non-legacy portion 854. The PPDU 850 may further include a PHY payload 856 after the preamble, for example, in the form of a PSDU including a data field 874.

The legacy portion 852 of the preamble includes an L-STF 858, an L-LTF 860, and an L-SIG 862. The non-legacy portion 854 of the preamble includes a repetition of L-SIG (RL-SIG) 864 and multiple wireless communication protocol version-dependent signal fields after RL-SIG 864. For example, the non-legacy portion 854 may include a universal signal field 866 (referred to herein as “U-SIG 866”) and an EHT signal field 868 (referred to herein as “EHT-SIG 868”). The presence of RL-SIG 864 and U-SIG 866 may indicate to EHT- or later version-compliant STAs 104 that the PPDU 850 is an EHT PPDU or a PPDU conforming to any later (post-EHT) version of a new wireless communication protocol conforming to a future IEEE 802.11 wireless communication protocol standard. One or both of U-SIG 866 and EHT-SIG 868 may be structured as, and carry version-dependent information for, other wireless communication protocol versions associated with amendments to the IEEE family of standards beyond EHT. For example, U-SIG 866 may be used by a receiving device to interpret bits in one or more of EHT-SIG 868 or the data field 874. Like L-STF 858, L-LTF 860, and L-SIG 862, the information in U-SIG 866 and EHT-SIG 868 may be duplicated and transmitted in each of the component 20 MHz channels in instances involving the use of a bonded channel.

The non-legacy portion 854 further includes an additional short training field 870 (referred to herein as “EHT-STF 870,” although it may be structured as, and carry version-dependent information for, other wireless communication protocol versions beyond EHT) and one or more additional long training fields 872 (referred to herein as “EHT-LTFs 872,” although they may be structured as, and carry version-dependent information for, other wireless communication protocol versions beyond EHT). EHT-STF 870 may be used for timing and frequency tracking and AGC, and EHT-LTF 872 may be used for more refined channel estimation.

EHT-SIG 868 may be used by an AP to identify and inform one or multiple STAs that the AP has scheduled uplink (UL) or downlink (DL) resources for them. EHT-SIG 868 may be decoded by each compatible STA 104 served by the AP 102. EHT-SIG 868 may generally be used by a receiving device to interpret bits in the data field 874. For example, EHT-SIG 868 may include RU allocation information, spatial stream configuration information, and per-user (for example, STA-specific) signaling information. Each EHT-SIG 868 may include a common field and at least one user-specific field. In the context of OFDMA, the common field can indicate RU distributions to multiple STAs, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs and carry STA-specific scheduling information such as user-specific modulation and coding scheme (MCS) values and user-specific RU allocation information. Such information enables the respective STAs to identify and decode corresponding RUs in the associated data field 874.

In some wireless communications environments, Extremely High Throughput (EHT) systems or other systems compliant with future generations of the IEEE 802.11 family of wireless communication protocol standards may provide additional capabilities over other previous systems (for example, High Efficiency (HE) systems or other legacy systems). EHT and newer wireless communication protocols may support flexible operating bandwidth enhancements at APs and STAs, such as broadened operating bandwidths relative to legacy operating bandwidths or more granular operation relative to legacy operation. For example, an EHT system may allow communications spanning operating bandwidths of 20 MHZ, 40 MHZ, 80 MHZ, 160 MHz, 240 MHz and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device operates in a contiguous 320 MHz bandwidth mode or a 160+160 MHz bandwidth mode. Signals for transmission may be generated by two different transmit chains of the device each having a bandwidth of 160 MHZ (and each coupled to a different power amplifier). In some other examples, signals for transmission may be generated by four or more different transmit chains of the device, each having a bandwidth of 80 MHZ.

In some other examples, the wireless communication device may operate in a contiguous 240 MHz bandwidth mode, or a noncontiguous 160+80 MHz bandwidth mode. In some examples, the signals for transmission may be generated by three different transmit chains of the device, each having a bandwidth of 80 MHZ. In some other examples, the 240 MHz/160+80 MHz bandwidth modes may also be formed by puncturing 320/160+160 MHz bandwidth modes with one or more 80 MHZ subchannels. For example, signals for transmission may be generated by two different transmit chains of the device each having a bandwidth of 160 MHz with one of the transmit chains outputting a signal having an 80 MHz subchannel punctured therein.

The operating bandwidth also may accommodate concurrent operation on other unlicensed frequency bands (such as the 6 GHz band) and a portion of spectrum that includes frequency bands traditionally used by Wi-Fi technology. In noncontiguous examples, the operating bandwidth may span one or more disparate sub-channel sets. For example, the 320 MHz bandwidth may be contiguous and located in the same 6 GHz band, or noncontiguous and located in different bands (such as partly in the 5 GHZ band and partly in the 6 GHz band).

In some examples, operability enhancements associated with EHT and newer generations of the IEEE 802.11 family of wireless communication protocols, and in particular operation at an increased bandwidth, may include refinements to carrier sensing and signal reporting mechanisms. Such techniques may include modifications to existing rules, structure, or signaling implemented for legacy systems.

Transmitting and receiving devices may support the use of various MCSs to transmit and receive data so as to optimally take advantage of wireless channel conditions, for example, to increase throughput, reduce latency, or enforce various quality of service (QOS) parameters. For example, existing technology supports the use of up to 1024-QAM, where a modulated symbol carries 10 bits. To further improve peak data rate, 4096-QAM (also referred to as “4k QAM”), which enables a modulated symbol to carry 12 bits, also may be implemented. 4096-QAM may enable a 20% increase in data rate compared to 1024-QAM given the same coding rate, thereby allowing users to obtain higher transmission efficiency.

As indicated above, FIG. 8 is provided as an example. Other examples may differ from what is described with regard to FIG. 8.

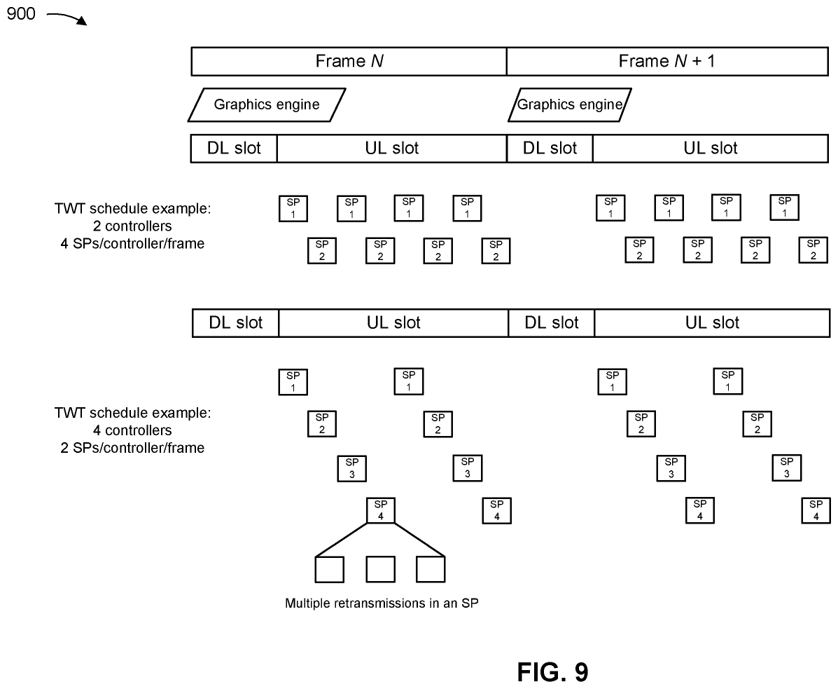

FIG. 9 is a diagram illustrating an example 900 of a scheduling hierarchy, in accordance with the present disclosure.

According to various aspects described herein, a central device (e.g., a WPAN scheduler, a gaming console for a gaming application) may indicate a flexible scheduling architecture to peripheral devices (e.g., gaming controllers for the application). The scheduling architecture may include a hierarchical design that splits communications during a rendered video frame of an application into a downlink slot and an uplink slot. Downlink data, such as haptics data, voice data, and/or audio data, can be transmitted during the downlink slot. A graphics engine may run at the beginning of the frame and use the downlink data to create the image of the rendered frame. The time that the graphics engine runs may vary based at least in part on the downlink data to be rendered, and the graphics engine may start at or near the beginning of the downlink slot. The duration of the downlink slot may be sufficient to support such data, and the frame structure may be associated with a frame refresh rate.

The central device may collect uplink data that can be used to render the next frame. Controllers may transmit the uplink data during an uplink slot of the same frame. The uplink slot may be split into multiple uplink SPs. Each controller may be assigned one or more SPs. In some aspects, the SPs may be allocated as TWT SPs, where an access point (gaming console) manages when the controllers wake up a radio for uplink access. Uplink data transmitted in the SPs may include control and/or voice data. In some aspects, an SP duration may be long enough to support retransmissions within the SP. Example 900 shows that an SP may support, for example, three retransmissions that can reduce latency.

In some aspects, the quantity of SPs and/or a duration of an SP in an uplink slot may be based at least in part on the quantity of controllers, an expected level of reliability, a TWT SP, and/or a TWT service interval (SI). Example 900 shows four SPs that can be used for each of two controllers or two SPs that can be used for each of four controllers in an uplink slot of a frame. There may be a tradeoff between the quantity of controllers, the reliability level, and/or a data sampling frequency (frame refresh rate).

By using a scheduling architecture that schedules downlink data during a downlink slot of a frame and uplink data during SPs assigned to peripheral devices (e.g., gaming controllers) in an uplink slot of the frame, a central device (e.g., a gaming console) may ensure that the controllers share uplink access in a way that can avoid collisions and provide for a more even distribution of uplink access during a video frame rendered for an application. In this way, the controllers have better timing and perform better for users than if there were no scheduled uplink access for the controllers during a frame.

Having all of the downlink data in a single downlink slot and all of the uplink data in a single uplink slot helps to reduce latency or potential collisions that may occur due to switching between uplink and downlink multiple times. However, in some aspects, instead of a downlink slot and an uplink slot in a frame, there may be one or more slots in the frame that allow for uplink or downlink data.

As indicated above, FIG. 9 is provided as an example. Other examples may differ from what is described with regard to FIG. 9.

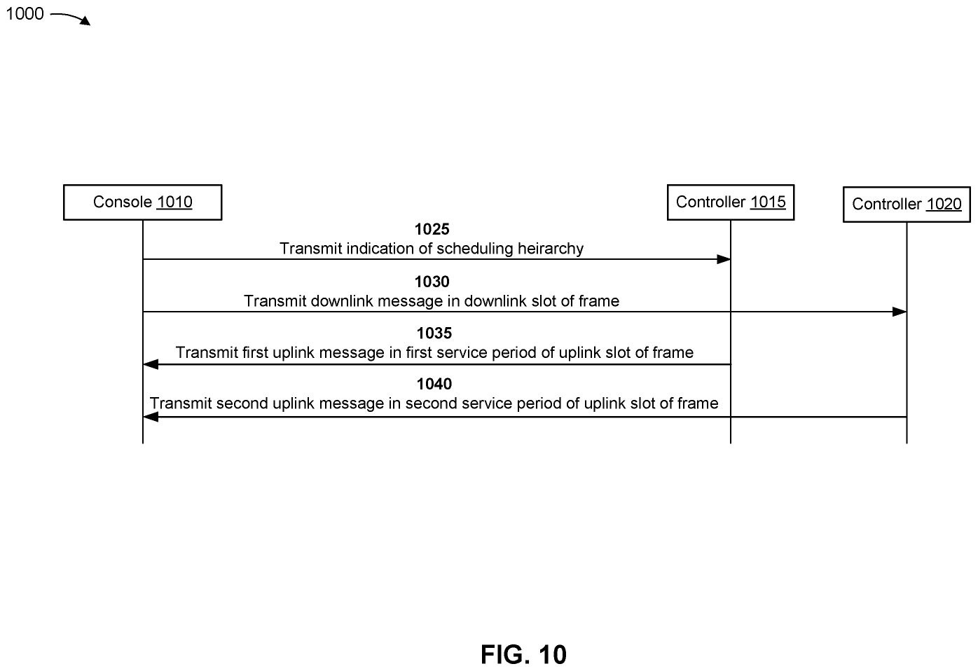

FIG. 10 is a diagram illustrating an example 1000 of indicating a scheduling hierarchy, in accordance with the present disclosure. Example 1000 shows a central device, such as a console 1010 (e.g., wireless communication device 200) that may communicate with peripheral devices, such as controller 1015 (e.g., wireless communication device 200) and controller 1020 (e.g., wireless communication device 200). The links between the console 1010 and the controllers may be Bluetooth links and/or Wi-Fi links.

As shown by reference number 1025, the console 1010 may transmit an indication of a scheduling hierarchy to the controller 1015 and the controller 1020. The scheduling hierarchy may specify that, within each frame rendered by the console 1010, a controller may receive downlink data from the console 1010 in a downlink slot and transmit available uplink data to the console 1010 within one or more first SPs that are respectively assigned to each controller in an uplink slot. In some aspects, the indication may configure the controllers with the scheduling hierarchy. In some aspects, the indication may request that the controllers follow the scheduling hierarchy.

As shown by reference number 1030, the console 1010 may transmit a downlink message in a downlink slot of a frame. The downlink message may include game information, video information to be rendered during the frame, haptic information (e.g., for vibrating a controller), and/or audio information to be played during the frame.

As shown by reference number 1035, the controller 1015 may transmit a first uplink message in a first SP (assigned to the controller 1015) of the uplink slot of the frame. As shown by reference number 1040, the controller 1020 may transmit a second uplink message in a second SP (assigned to the controller 1020) of the uplink slot of the frame. The first uplink message and/or the second uplink message may include controller action information (e.g., button presses, joystick movements, audio). That is, the downlink data may be limited to a downlink slot of a frame and uplink data may be limited to an uplink slot of the same frame, where the controllers use SPs to share the uplink slot. The SPs may be scheduled using a TWT or similar protocol.

As indicated above, FIG. 10 is provided as an example. Other examples may differ from what is described with regard to FIG. 10.

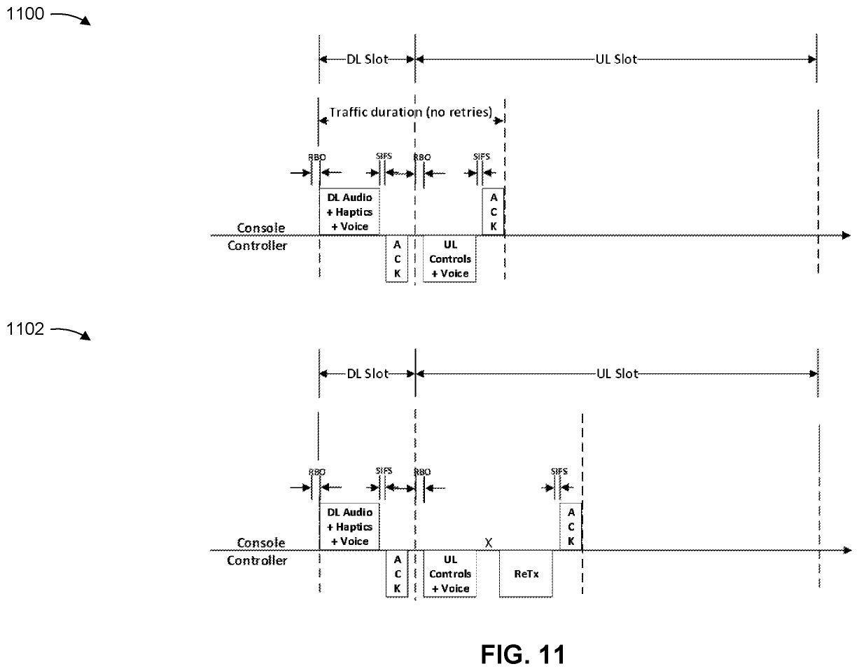

FIG. 11 is a diagram illustrating examples 1100 and 1102 of traffic patterns for a single controller, in accordance with the present disclosure. The traffic patterns may be between a central device (e.g., console) and the controller. There may be a short distance between the console and the controller.

Example 1100 shows the timing of downlink data in a downlink slot and uplink data in an uplink slot. The downlink traffic in the downlink slot may include haptics feedback (e.g., 20 bytes), voice data at 128 kilobytes per second (kbps) (134 bytes/8.33 ms frame), and/or audio data at 384 kbps (400 bytes/8.33 ms frame). The downlink audio data may be combined with voice data and haptics feedback in the same PPDU. Downlink haptics feedback may have a lower periodicity compared to uplink data for uplink controls. The uplink traffic in the uplink slot may include a controller button push (e.g., 32 bytes) and/or voice data at 128 kbps (134 bytes/8.33 ms frame). There may be an acknowledgement (ACK) for the downlink data and for the uplink data. Example 1100 does not provide for retries but example 1102 shows there may be a retransmission (ReTx) during the uplink slot.

As indicated above, FIG. 11 is provided as an example. Other examples may differ from what is described with regard to FIG. 11.

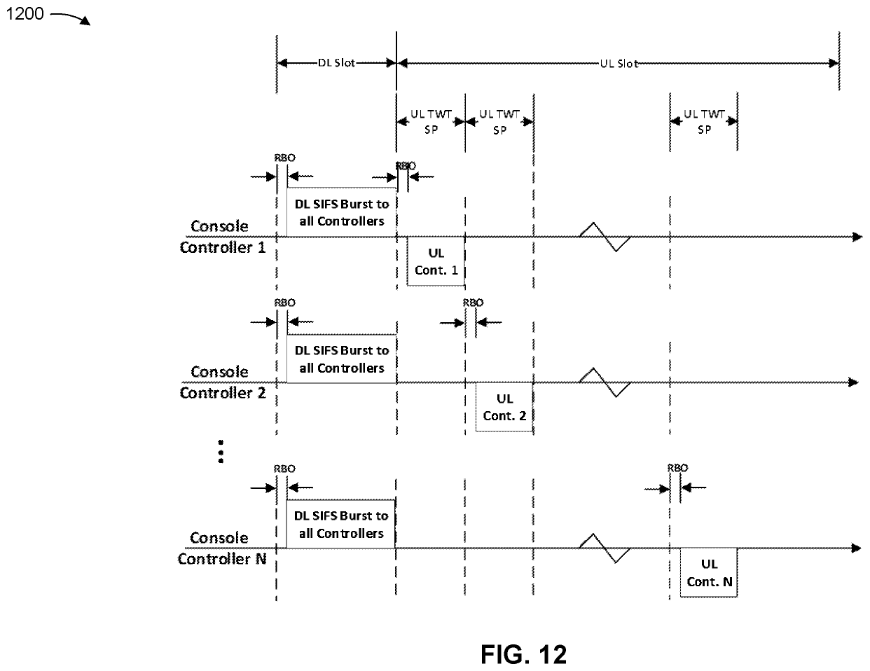

FIG. 12 is a diagram illustrating an example 1200 of traffic patterns for multiple controllers, in accordance with the present disclosure. Example 1200 shows a timing of communications during a frame between a central device (e.g., console) and multiple peripheral devices (e.g., controller 1, controller 2, and controller 3).

Example 1200 shows a short interframe space (SIFS) burst of downlink data in a downlink slot of the frame. A random access scheme may be used for uplink access. The random access scheme may involve sensing the channel and backing off a random amount of time before transmitting or sensing again in the frame. This may also be referred to as “random backoff” or “RBO.” While example 1200 shows a multi-destination SIFS burst, there may be downlink TWT SPs in the downlink slot.

Example 1200 also shows individual TWT SPs for uplink access in an uplink slot. There may be one announced TWT session for uplink (UL) traffic and one unannounced TWT session for downlink (DL) traffic per controller. This may allow for independently setting a downlink and uplink TWT SI (which is beneficial for use cases with no downlink audio/voice traffic). Example 1200 assumes a clean channel with no retransmissions, and one controller is expected to use, for example, about 150 us for uplink traffic at MCS 3.

In some aspects, the SPs assigned to multiple controllers may not overlap. A sequence of uplink access may include uplink data from controller 1 and uplink data from controller 2, up through the uplink data from controller N.

As indicated above, FIG. 12 is provided as an example. Other examples may differ from what is described with regard to FIG. 12.

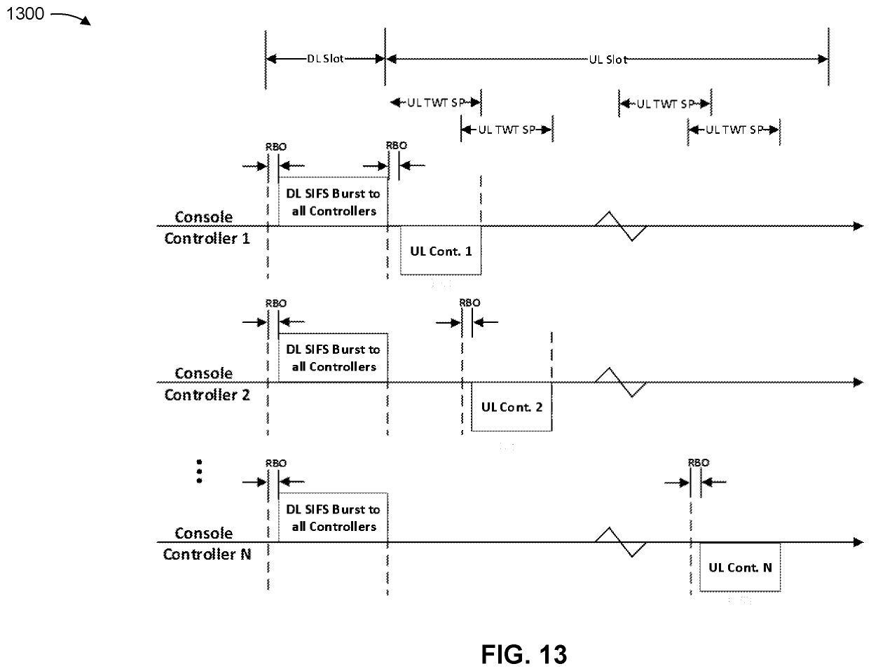

FIG. 13 is a diagram illustrating an example 1300 of traffic patterns for multiple controllers, in accordance with the present disclosure.

In some aspects, the SPs assigned to multiple controllers may partially overlap. A sequence of uplink access may include uplink data from controller 1 and uplink data from controller 2, up through the uplink data from controller N. However, some SPs may overlap. For example, the SP for controller 1 may partially overlap with the SP for controller 2. This may be beneficial if the MCS or the quantity of retries changes. Overlapping SPs may allow for a more efficient use of airtime. A controller with an overlapping TWT SP can obtain the medium or access the channel, but the controllers may use TWT offsets that are designed to allow only two controllers to overlap (to avoid collisions). The TWT offsets may be dynamically adapted and communicated to controllers through vendor-specific action frames.

As indicated above, FIG. 13 is provided as an example. Other examples may differ from what is described with regard to FIG. 13.

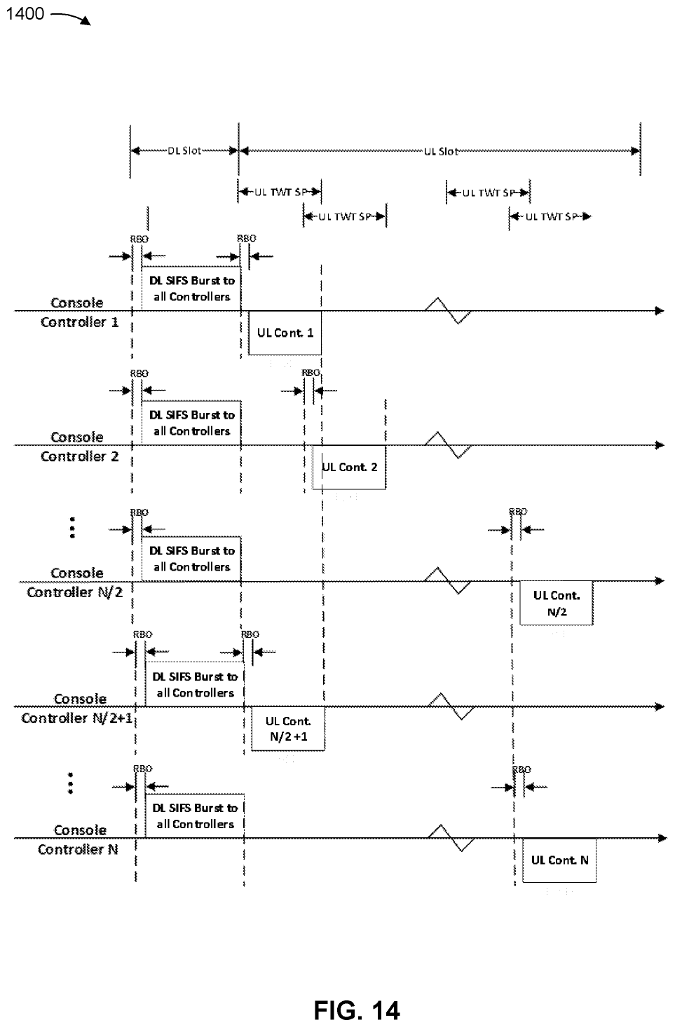

FIG. 14 is a diagram illustrating an example 1400 of traffic patterns for multiple controllers, in accordance with the present disclosure.

In some aspects, some controllers may share an SP. For example, controller n and controller N/2+n may share an SP, where N is the total quantity of controllers. Example 1400 shows that controller 1 and controller N/2+1 may share an SP. The oversubscription of controllers may be based at least in part on the TWT SI. For example, a TWT SI of 2 ms may accommodate 6 controllers with a total of two uplink retries at MCS 3 without audio traffic. Alternatively, the TWT SI may be increased conditionally if more controllers are connected. A TWT SI of 3 ms may allow 6 controllers with 1 retry each (i.e., total of 6 retries at MCS 2).

There may be some flexibility and scalability in the schedule design. In some aspects, the quantity of allowed retries per controller for uplink traffic (or for the console for downlink traffic) may be based at least in part on the total quantity of controllers, the MCS, and/or the traffic pattern. The quantity of individual SPs per controller in a frame may be based at least in part on the quantity of controllers, a TWT SP duration, and/or the TWT SI. The quantity of individual SPs per controller in a frame may also be based at least in part on the refresh rate of controller data.

As indicated above, FIG. 14 is provided as an example. Other examples may differ from what is described with regard to FIG. 14.

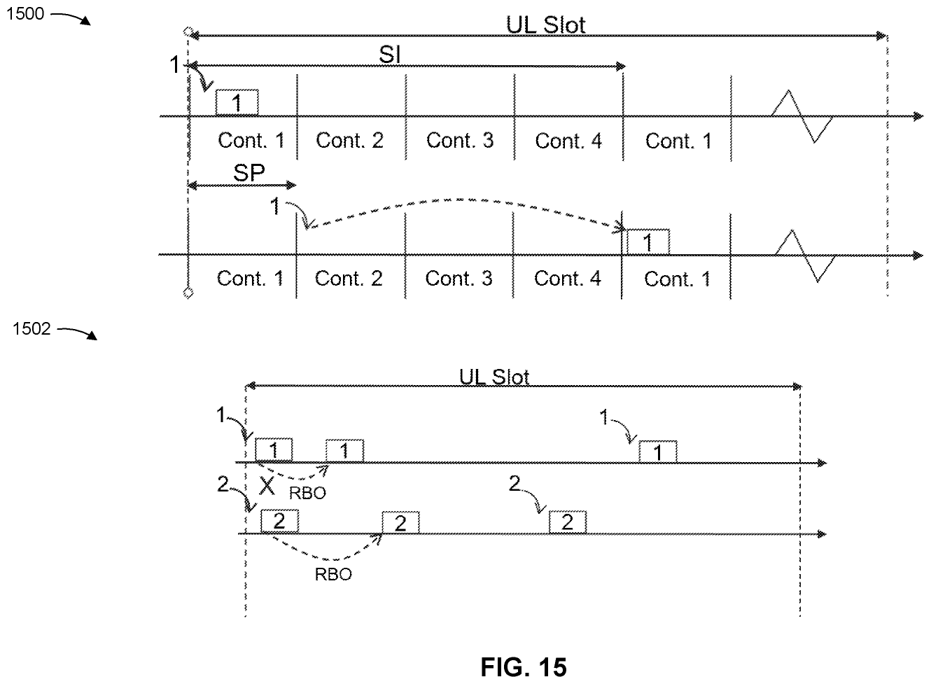

FIG. 15 is a diagram illustrating examples 1500 and 1502 of access schemes, in accordance with the present disclosure.

In some scenarios, there may be multiple controllers seeking uplink access at the same time during an SP. Different access schemes may be used for such scenarios.

Example 1500 shows a scheduled access scheme. A first controller may wait for a next SP if a packet (e.g., a button push/sensor data shown by the box with “1” inside) for the first controller arrives or occurs after the assigned SP of the first controller. The packet may have either arrived completely after the assigned SP or after a threshold time before the end of the assigned SP that prevents the packet from being completely transmitted in the remaining time until the end of the SP. Example 1500 shows that the packet is transmitted in the next SP assigned to the first controller. That is, if a controller misses its allocated TWT SP, the controller is expected to wait until its assigned SP in the upcoming TWT SI. As a result, there may be no packet collisions between the controllers and the console in the scheduled access scheme. The SP may be determined by

$$SP = \frac{S I}{N} ,$$

where SI is the TWT SI, SP is TWT SP, and Nis total quantity of controllers. The P99 latency (where 99% of packets are faster than this latency) may be about

$$SI - \frac{S P}{2} = SI ( 1 - \frac{1}{2 N} ) .$$

As N increases, the P99 latency increases.

Example 1502 shows a random access scheme with a random backoff (RBO). In this scheme, controllers contend on the channel in the assigned uplink SP whenever data is to be transmitted. The controllers may contend with access category voice (AC_VO) enhanced distributed channel access (EDCA) parameters, which affects traffic flowing from an AP to STAs. A first controller may transmit its data whenever the data arrives, if the channel is idle, and does not wait until the next TWT SI window. However, if the channel is not clear, the first controller waits a random amount of time (as part of RBO) before transmitting or sensing again (within the same frame or TWT SI). A second controller, if the channel is not clear, also waits a random amount of time, which can be a different amount of time. With this scheme, the probability of a collision and the P99 latency increases as N increases.

As indicated above, FIG. 15 provides some examples. Other examples may differ from what is described with regard to FIG. 15.

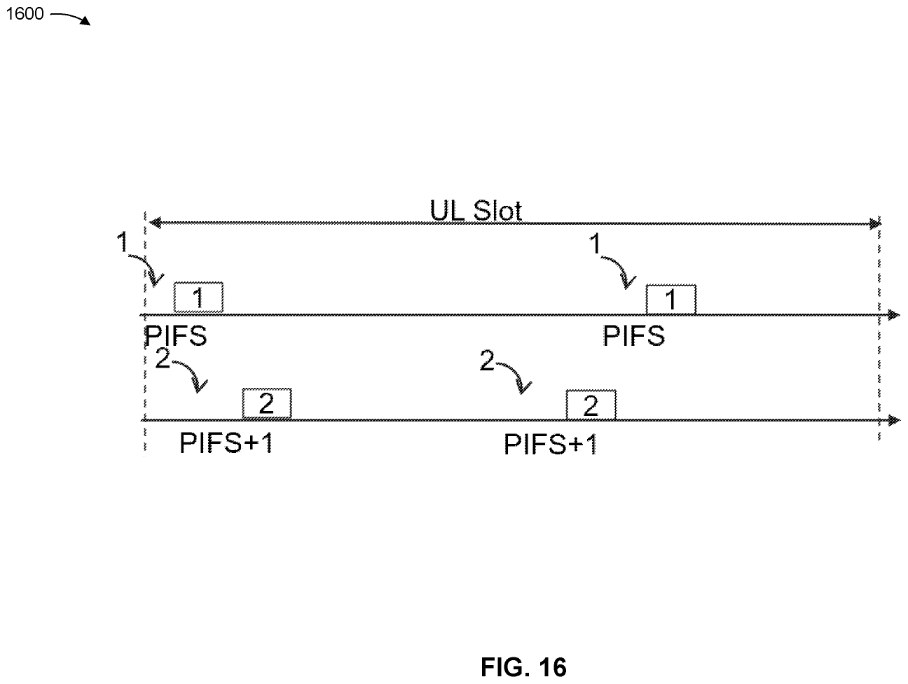

FIG. 16 is a diagram illustrating an example 1600 of a contention free access scheme, in accordance with the present disclosure.

In some aspects, there may be an agreement between the console and controllers for channel access. For example, the console may access the medium with a point coordination function (PCF) interframe space (PIFS), and a controller n may access the medium at PIFS+n, where n may be 0 through N−1. Each controller may be assigned an offset (not random) that is a multiple of n after the PIFS. Example 1600 shows a first controller transmitting based at least in part on the PIFS (e.g., after the PIFS). A second controller may transmit at PIFS+1. In this example, there is no offset for the first controller, but the first controller may start with a first offset and the second controller may have a second offset.

To mitigate the unfairness of some controllers having priority access compared to others, the agreement may include a pattern for a controller's backoff, such as PIFS+ (AID+priorityₛₗₒₜ_{_{idx}})) modulo N and priority_slot_idx=t/priority_dur, where t is the running time and AID is an association identifier (ID). Priority_dur may be the duration (e.g., μs) during which a certain order is maintained (or the periodicity that the console changes the priority order with). For example, the console may want to change the channel access priority order once every 10 minutes. Priority_slot_index may be an index for the current time relative to the priority_dur parameter. For example, priority_dur may be 10 minutes. The operation t/priority_dur may be an integer division operation or a floor operation. The parameters may be used to determine the offset (on top of PIFS) that a controller is to use at a given time instant (to allow randomization of the order of channel access among controllers and hence provide fairness). For t=0 to 10 minutes, priority_slot_index=0 and the first controller may use PIFS+ (AID+0) modulo N=PIFS+AID. For t=10 to 20 minutes, priority_slot_index=1 and the first controller may use PIFS+ (AID+1) modulo N=PIFS+AID+1, and so forth. Similarly, other controllers may calculate the offset based at least in part on the time and their respective AIDs.

The console may indicate an offset pattern to the controllers. The console may indicate the priority duration and the AID to the controllers upon connection and may modify such parameters or the offset pattern through a vendor-specific action frame. The contention-free access scheme may allow for a faster transmission upon packet arrival.

In some aspects, the console may select an access scheme from among a scheduled access scheme, a random access scheme, and a contention free access scheme and transmit an indication of the access scheme. The console may select the access scheme based at least in part on a quantity of connected peripheral devices and/or an assessment (e.g., measurement) of a channel congestion level.

As indicated above, FIG. 16 is provided as an example. Other examples may differ from what is described with regard to FIG. 16.

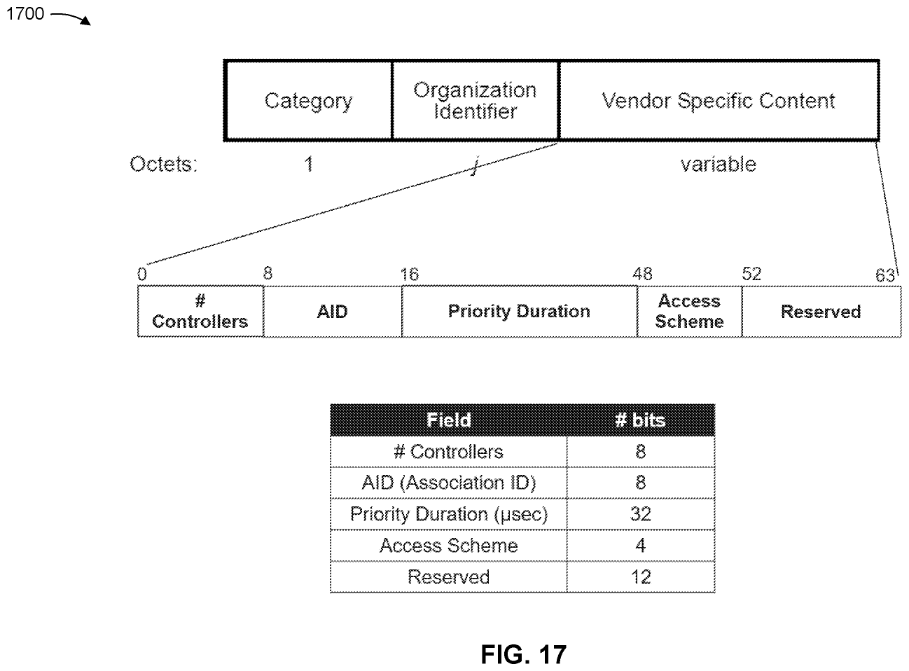

FIG. 17 is a diagram illustrating an example 1700 of vendor specific content, in accordance with the present disclosure.

In some aspects, the console may indicate an access scheme and/or dynamically change between a previous channel access scheme through the use of a vendor-specific action frame or field. For example, the console may select the random access scheme for a smaller quantity of controllers (e.g., less than a threshold) and the scheduled access scheme for a large number of controllers (e.g., equal to or greater than the threshold). As described above, the vendor-specific action frame may include one or more fields, such as a quantity of controllers, an AID, a priority duration, an access scheme, and/or reserved. The vendor-specific action frame may also provide channel access priority fairness among the peripheral devices to avoid, for example, scenarios when a specific controller always accesses the medium with a smaller offset than other devices.

As indicated above, FIG. 17 is provided as an example. Other examples may differ from what is described with regard to FIG. 17.

In some aspects, the central device may use a clean channel (e.g., a dynamic frequency selection (DFS) channel or a clean 6G channel) to reduce interference or collisions over the air. The central device may monitor home channel quality/congestion and use dynamic channel switching (DCS) to ensure the continuous use of a clean channel. The central device may use AC_VO for both downlink and uplink traffic for prioritized channel access. The central device may use ACK rate adaptation based at least in part on an incoming MCS for a smaller ACK overhead.

The central device may optimize use of the scheduling architecture to obtain various advantages. In some aspects, the central device may use independent uplink and downlink TWTs per controller for independent control of uplink and downlink traffic periodicity to ensure no collisions between downlink and uplink traffic. The central device may use multi-destination SIFS bursting for downlink traffic to all controllers to reduce channel access overhead. The central device may use overlapping TWT SPs with fixed or dynamic offsets for better TWT SI airtime utilization. For a large quantity of controllers, the central device may oversubscribe existing TWT SPs with the same TWT SI/E2E latency, or increase TWT SI/E2E latency with better reliability for better scalability of the quantity of supported controllers. The central device may use an adaptive scheduling access technique to select the best scheduler for each scenario based at least in part on the quantity of clients and/or the desired reliability.

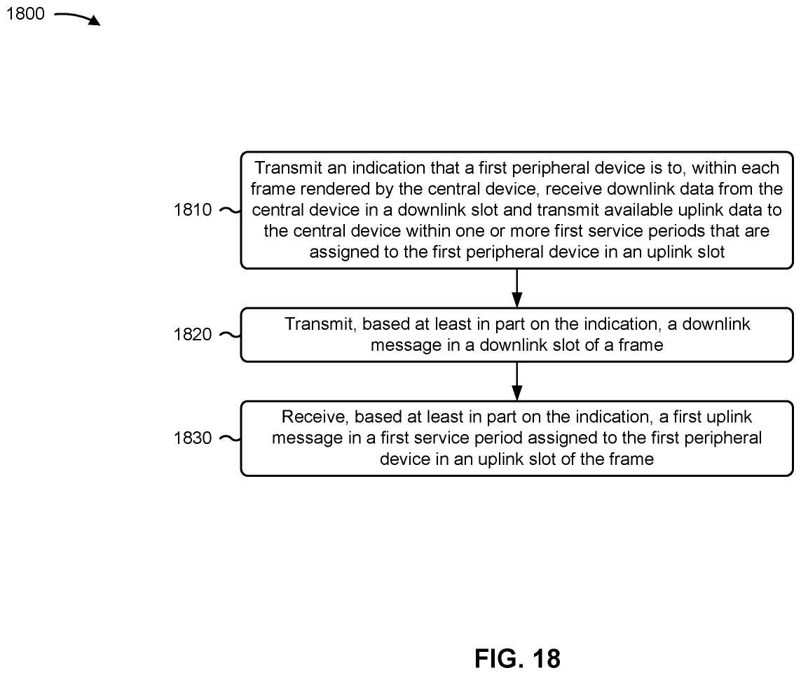

FIG. 18 is a diagram illustrating an example process 1800 performed, for example, by a central device, in accordance with the present disclosure. Example process 1800 is an example where the central device (e.g., wireless communication device 200, console 1010) performs operations associated with scheduling communications within a frame.

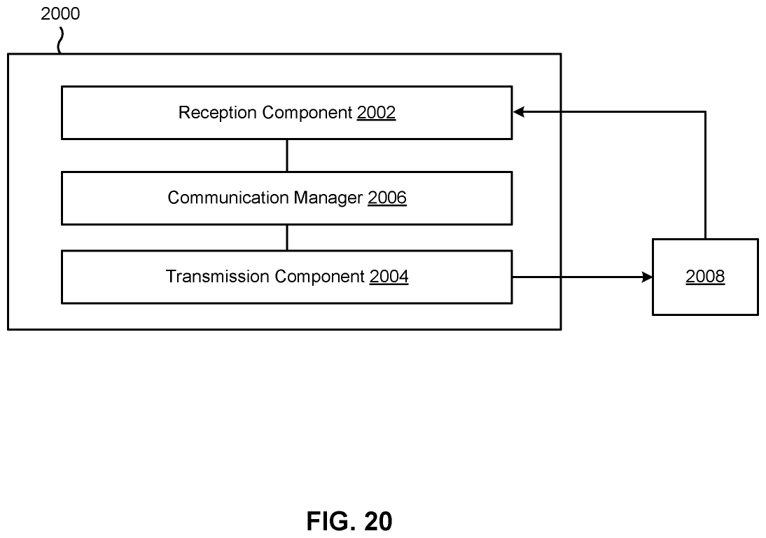

As shown in FIG. 18, in some aspects, process 1800 may include transmitting an indication that a first peripheral device is to, within each frame rendered by the central device, receive downlink data from the central device in a downlink slot and transmit available uplink data to the central device within one or more first service periods that are assigned to the first peripheral device in an uplink slot (block 1810). For example, the central device (e.g., using transmission component 2004 and/or communication manager 2006, depicted in FIG. 20) may transmit an indication that a first peripheral device is to, within each frame rendered by the central device, receive downlink data from the central device in a downlink slot and transmit available uplink data to the central device within one or more first service periods that are assigned to the first peripheral device in an uplink slot, as described above.

As further shown in FIG. 18, in some aspects, process 1800 may include transmitting, based at least in part on the indication, a downlink message in a downlink slot of a frame (block 1820). For example, the central device (e.g., using transmission component 2004 and/or communication manager 2006, depicted in FIG. 20) may transmit, based at least in part on the indication, a downlink message in a downlink slot of a frame, as described above.

As further shown in FIG. 18, in some aspects, process 1800 may include receiving, based at least in part on the indication, a first uplink message in a first service period assigned to the first peripheral device in an uplink slot of the frame (block 1830). For example, the central device (e.g., using reception component 2002 and/or communication manager 2006, depicted in FIG. 20) may receive, based at least in part on the indication, a first uplink message in a first service period assigned to the first peripheral device in an uplink slot of the frame, as described above.

Process 1800 may include additional aspects, such as any single aspect or any combination of aspects described below and/or in connection with one or more other processes described elsewhere herein. Note that that information provided to the first peripheral device may be provided to a second peripheral device and to other peripheral devices.

In a first aspect, the one or more first service periods share the uplink slot with one or more second service periods assigned to a second peripheral device.

In a second aspect, alone or in combination with the first aspect, the one or more first service periods do not overlap in time with the one or more second service periods.

In a third aspect, alone or in combination with one or more of the first and second aspects, the one or more first service periods partially overlap in time with the one or more second service periods.

In a fourth aspect, alone or in combination with one or more of the first through third aspects, the first peripheral device shares the one or more first service periods with one or more other peripheral devices.

In a fifth aspect, alone or in combination with one or more of the first through fourth aspects, the indication indicates whether the first peripheral device and the second peripheral device follow a scheduled access scheme or a random access scheme for an uplink channel access between the first uplink message of the first peripheral device and a second uplink message of the second peripheral device in a service period.

In a sixth aspect, alone or in combination with one or more of the first through fifth aspects, the scheduled access scheme specifies that the first uplink message is to wait until a next service period of the one or more first service periods.

In a seventh aspect, alone or in combination with one or more of the first through sixth aspects, the random access scheme specifies that the first uplink message or the second uplink message is to sense a channel to the central device and backoff a random amount of time before sensing again within the uplink slot based at least in part on a channel to the central device not being clear.

In an eighth aspect, alone or in combination with one or more of the first through seventh aspects, the indication indicates that the first peripheral device follows a contention free access scheme for an uplink channel access between the first uplink message of the first peripheral device and a second uplink message of the second peripheral device in a service period, where the contention free access scheme specifies that the first peripheral device is to transmit the first uplink message based at least in part on an interframe space plus a first offset or no offset and that the second peripheral device is to transmit a second uplink message based at least in part on the interframe space plus a second offset assigned to the second peripheral device.

In a ninth aspect, alone or in combination with one or more of the first through eighth aspects, process 1800 includes transmitting an offset pattern for the first offset and the second offset in a vendor-specific action frame, or a vendor-specific content field in a vendor-specific action frame.

In a tenth aspect, alone or in combination with one or more of the first through ninth aspects, process 1800 includes selecting an access scheme from among a scheduled access scheme, a random access scheme, and a contention free access scheme based at least in part on one or more of a quantity of connected peripheral devices or an assessment of a channel congestion level.

In an eleventh aspect, alone or in combination with one or more of the first through tenth aspects, transmitting the indication includes transmitting the indication in a vendor-specific action frame, or a vendor-specific content field in a vendor-specific action frame.

In a twelfth aspect, alone or in combination with one or more of the first through eleventh aspects, the one or more first service periods are assigned to the first peripheral device in accordance with a target wake time schedule. Service periods for other peripheral devices, such as the second peripheral device may also be assigned.

In a thirteenth aspect, alone or in combination with one or more of the first through twelfth aspects, the one or more first service periods are configured based at least in part on a quantity of other peripheral devices that use the central device.

In a fourteenth aspect, alone or in combination with one or more of the first through thirteenth aspects, the one or more first service periods are configured based at least in part on a reliability parameter.

In a fifteenth aspect, alone or in combination with one or more of the first through fourteenth aspects, the one or more first service periods are configured based at least in part on a data sampling frequency or a refresh rate for peripheral device data.

In a sixteenth aspect, alone or in combination with one or more of the first through fifteenth aspects, each service period, of the one or more first service periods, supports retransmissions.

In a seventeenth aspect, alone or in combination with one or more of the first through sixteenth aspects, each service period, of the one or more first service periods, is based at least in part on one or more of a type of uplink data or a data rate expectation of uplink data.

In an eighteenth aspect, alone or in combination with one or more of the first through seventeenth aspects, the indication indicates a maximum quantity of transmission retries for the first peripheral device based at least in part on one or more of a quantity of other peripheral devices that use the central device, a modulation and coding scheme used by the central device, or a traffic pattern of data associated with the central device.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

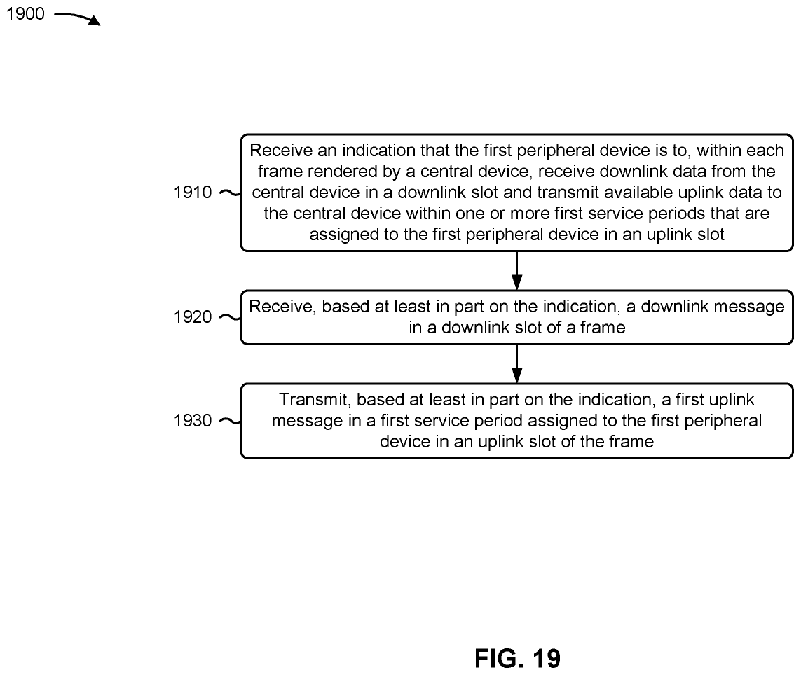

FIG. 19 is a diagram illustrating an example process 1900 performed, for example, by a first peripheral device, in accordance with the present disclosure. Example process 1900 is an example where the first peripheral device (e.g., wireless communication device 200, controller 1015, controller 1020) performs operations associated with scheduling communication within a frame.

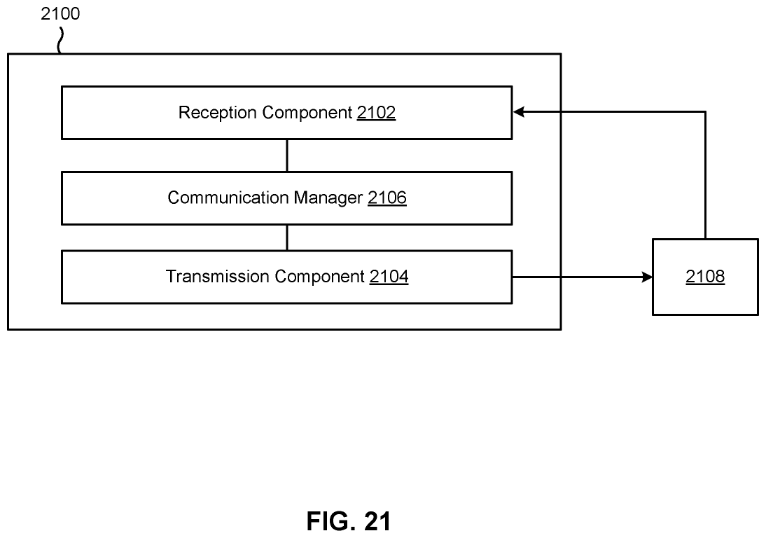

As shown in FIG. 19, in some aspects, process 1900 may include receiving an indication that the first peripheral device is to, within each frame rendered by a central device, receive downlink data from the central device in a downlink slot and transmit available uplink data to the central device within one or more first service periods that are assigned to the first peripheral device in an uplink slot (block 1910). For example, the first peripheral device (e.g., using reception component 2102 and/or communication manager 2106, depicted in FIG. 21) may receive an indication that the first peripheral device is to, within each frame rendered by a central device, receive downlink data from the central device in a downlink slot and transmit available uplink data to the central device within one or more first service periods that are assigned to the first peripheral device in an uplink slot, as described above.

As further shown in FIG. 19, in some aspects, process 1900 may include receiving, based at least in part on the indication, a downlink message in a downlink slot of a frame (block 1920). For example, the first peripheral device (e.g., using reception component 2102 and/or communication manager 2106, depicted in FIG. 21) may receive, based at least in part on the indication, a downlink message in a downlink slot of a frame, as described above.

As further shown in FIG. 19, in some aspects, process 1900 may include transmitting, based at least in part on the indication, a first uplink message in a first service period assigned to the first peripheral device in an uplink slot of the frame (block 1930). For example, the first peripheral device (e.g., using transmission component 2104 and/or communication manager 2106, depicted in FIG. 21) may transmit, based at least in part on the indication, a first uplink message in a first service period assigned to the first peripheral device in an uplink slot of the frame, as described above.

Process 1900 may include additional aspects, such as any single aspect or any combination of aspects described below and/or in connection with one or more other processes described elsewhere herein.

In a first aspect, the one or more first service periods share the uplink slot with one or more second service periods assigned to a second peripheral device.

In a second aspect, alone or in combination with the first aspect, the one or more first service periods do not overlap in time with the one or more second service periods.

In a third aspect, alone or in combination with one or more of the first and second aspects, the one or more first service periods partially overlap in time with the one or more second service periods.

In a fourth aspect, alone or in combination with one or more of the first through third aspects, the first peripheral device shares the one or more first service periods with one or more other peripheral devices.

In a fifth aspect, alone or in combination with one or more of the first through fourth aspects, the indication indicates whether the first peripheral device and the second peripheral device follow a scheduled access scheme or a random access scheme for an uplink channel access between the first uplink message of the first peripheral device and a second uplink message of the second peripheral device in a service period.

In a sixth aspect, alone or in combination with one or more of the first through fifth aspects, the indication indicates that the first peripheral device follows a contention free access scheme for an uplink channel access between the first uplink message of the first peripheral device and a second uplink message of the second peripheral device in a service period, where the contention free access scheme specifies that the first peripheral device is to transmit the first uplink message based at least in part on an interframe space plus a first offset or no offset and that the second peripheral device is to transmit a second uplink message based at least in part on the interframe space plus a second offset assigned to the second peripheral device. Process 1900 may include performing one or more operations and/or calculations to derive a value of an offset assigned to the first peripheral device and/or the second peripheral device. The value may be valid for a certain period of time. The offset may change over time to offer channel access order fairness among the devices.

Although FIG. 19 shows example blocks of process 1900, in some aspects, process 1900 may include additional blocks, fewer blocks, different blocks, or differently arranged blocks than those depicted in FIG. 19. Additionally, or alternatively, two or more of the blocks of process 1900 may be performed in parallel.

FIG. 20 is a diagram of an example apparatus 2000 for wireless communication, in accordance with the present disclosure. The apparatus 2000 may be a central device (e.g., wireless communication device 200, console 1010), or a central device may include the apparatus 2000. In some aspects, the apparatus 2000 includes a reception component 2002, a transmission component 2004, and/or a communication manager 2006, which may be in communication with one another (for example, via one or more buses and/or one or more other components).

In some aspects, the apparatus 2000 may be configured to perform one or more operations described herein in connection with FIGS. 1-17. Additionally, or alternatively, the apparatus 2000 may be configured to perform one or more processes described herein, such as process 1800 of FIG. 18. In some aspects, the apparatus 2000 and/or one or more components shown in FIG. 20 may include one or more components of the central device described in connection with FIG. 2 and/or FIG. 5. Additionally, or alternatively, one or more components shown in FIG. 20 may be implemented within one or more components described in connection with FIG. 2 and/or FIG. 5. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2002 may receive communications, such as reference signals, control information, data communications, or a combination thereof, from the apparatus 2008. The reception component 2002 may provide received communications to one or more other components of the apparatus 2000. In some aspects, the reception component 2002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2000. In some aspects, the reception component 2002 may include one or more antennas, a modem, a demodulator, a MIMO detector, a receive processor, a controller/processor, a memory, or a combination thereof, of the central device described in connection with FIG. 2 and/or FIG. 5.

The transmission component 2004 may transmit communications, such as reference signals, control information, data communications, or a combination thereof, to the apparatus 2008. In some aspects, one or more other components of the apparatus 2000 may generate communications and may provide the generated communications to the transmission component 2004 for transmission to the apparatus 2008. In some aspects, the transmission component 2004 may perform signal processing on the generated communications (such as filtering, amplification, modulation, digital-to-analog conversion, multiplexing, interleaving, mapping, or encoding, among other examples), and may transmit the processed signals to the apparatus 2008. In some aspects, the transmission component 2004 may include one or more antennas, a modem, a modulator, a transmit MIMO processor, a transmit processor, a controller/processor, a memory, or a combination thereof, of the central device described in connection with FIG. 2 and/or FIG. 5. In some aspects, the transmission component 2004 may be co-located with the reception component 2002 in a transceiver.

The communication manager 2006 may support operations of the reception component 2002 and/or the transmission component 2004. For example, the communication manager 2006 may receive information associated with configuring reception of communications by the reception component 2002 and/or transmission of communications by the transmission component 2004. Additionally, or alternatively, the communication manager 2006 may generate and/or provide control information to the reception component 2002 and/or the transmission component 2004 to control reception and/or transmission of communications.

The transmission component 2004 may transmit an indication that a first peripheral device is to, within each frame rendered by the central device, receive downlink data from the central device in a downlink slot and transmit available uplink data to the central device within one or more first service periods that are assigned to the first peripheral device in an uplink slot. The transmission component 2004 may transmit, based at least in part on the indication, a downlink message in a downlink slot of a frame. The reception component 2002 may receive, based at least in part on the indication, a first uplink message in a first service period assigned to the first peripheral device in an uplink slot of the frame. The transmission component 2004 may transmit an offset pattern for the first offset and the second offset in a vendor-specific action frame, or vendor-specific content field in a vendor-specific action frame.

The communication manager 2006 may select an access scheme from among a scheduled access scheme, a random access scheme, and a contention free access scheme based at least in part on one or more of a quantity of connected peripheral devices or an assessment of a channel congestion level.

The number and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally, or alternatively, a set of (one or more) components shown in FIG. 20 may perform one or more functions described as being performed by another set of components shown in FIG. 20.

FIG. 21 is a diagram of an example apparatus 2100 for wireless communication, in accordance with the present disclosure. The apparatus 2100 may be a peripheral device (e.g., wireless communication device 200, controller 1015, controller 1020), or a peripheral device may include the apparatus 2100. In some aspects, the apparatus 2100 includes a reception component 2102, a transmission component 2104, and/or a communication manager 2106, which may be in communication with one another (for example, via one or more buses and/or one or more other components).

In some aspects, the apparatus 2100 may be configured to perform one or more operations described herein in connection with FIGS. 1-17. Additionally, or alternatively, the apparatus 2100 may be configured to perform one or more processes described herein, such as process 1900 of FIG. 19. In some aspects, the apparatus 2100 and/or one or more components shown in FIG. 21 may include one or more components of the peripheral device described in connection with FIG. 2 and/or FIG. 5. Additionally, or alternatively, one or more components shown in FIG. 21 may be implemented within one or more components described in connection with FIG. 2 and/or FIG. 5. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2102 may receive communications, such as reference signals, control information, data communications, or a combination thereof, from the apparatus 2108. The reception component 2102 may provide received communications to one or more other components of the apparatus 2100. In some aspects, the reception component 2102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2100. In some aspects, the reception component 2102 may include one or more antennas, a modem, a demodulator, a MIMO detector, a receive processor, a controller/processor, a memory, or a combination thereof, of the peripheral device described in connection with FIG. 2 and/or FIG. 5.

The transmission component 2104 may transmit communications, such as reference signals, control information, data communications, or a combination thereof, to the apparatus 2108. In some aspects, one or more other components of the apparatus 2100 may generate communications and may provide the generated communications to the transmission component 2104 for transmission to the apparatus 2108. In some aspects, the transmission component 2104 may perform signal processing on the generated communications (such as filtering, amplification, modulation, digital-to-analog conversion, multiplexing, interleaving, mapping, or encoding, among other examples), and may transmit the processed signals to the apparatus 2108. In some aspects, the transmission component 2104 may include one or more antennas, a modem, a modulator, a transmit MIMO processor, a transmit processor, a controller/processor, a memory, or a combination thereof, of the peripheral device described in connection with FIG. 2 and/or FIG. 5. In some aspects, the transmission component 2104 may be co-located with the reception component 2102 in a transceiver.

The communication manager 2106 may support operations of the reception component 2102 and/or the transmission component 2104. For example, the communication manager 2106 may receive information associated with configuring reception of communications by the reception component 2102 and/or transmission of communications by the transmission component 2104. Additionally, or alternatively, the communication manager 2106 may generate and/or provide control information to the reception component 2102 and/or the transmission component 2104 to control reception and/or transmission of communications.

The reception component 2102 may receive an indication that the first peripheral device is to, within each frame rendered by a central device, receive downlink data from the central device in a downlink slot and transmit available uplink data to the central device within one or more first service periods that are assigned to the first peripheral device in an uplink slot. The reception component 2102 may receive, based at least in part on the indication, a downlink message in a downlink slot of a frame. The transmission component 2104 may transmit, based at least in part on the indication, a first uplink message in a first service period assigned to the first peripheral device in an uplink slot of the frame.

The number and arrangement of components shown in FIG. 21 are provided as an example. In practice, there may be additional components, fewer components, different components, or differently arranged components than those shown in FIG. 21. Furthermore, two or more components shown in FIG. 21 may be implemented within a single component, or a single component shown in FIG. 21 may be implemented as multiple, distributed components. Additionally, or alternatively, a set of (one or more) components shown in FIG. 21 may perform one or more functions described as being performed by another set of components shown in FIG. 21.

The following provides an overview of some Aspects of the present disclosure:

Aspect 1: A method of wireless communication performed by a central device, comprising: transmitting an indication that a first peripheral device is to, within each frame rendered by the central device, receive downlink data from the central device in a downlink slot and transmit available uplink data to the central device within one or more first service periods that are assigned to the first peripheral device in an uplink slot; transmitting, based at least in part on the indication, a downlink message in a downlink slot of a frame; and receiving, based at least in part on the indication, a first uplink message in a first service period assigned to the first peripheral device in an uplink slot of the frame.

Aspect 2: The method of Aspect 1, wherein the one or more first service periods share the uplink slot with one or more second service periods assigned to a second peripheral device.

Aspect 3: The method of Aspect 2, wherein the one or more first service periods do not overlap in time with the one or more second service periods.

Aspect 4: The method of Aspect 2, wherein the one or more first service periods partially overlap in time with the one or more second service periods.

Aspect 5: The method of Aspect 2, wherein the first peripheral device shares the one or more first service periods with one or more other peripheral devices.

Aspect 6: The method of Aspect 2, wherein the indication indicates whether the first peripheral device and the second peripheral device follow a scheduled access scheme or a random access scheme for an uplink channel access between the first uplink message of the first peripheral device and a second uplink message of the second peripheral device in a service period.

Aspect 7: The method of Aspect 6, wherein the scheduled access scheme specifies that the first uplink message is to wait until a next service period of the one or more first service periods.

Aspect 8: The method of Aspect 6, wherein the random access scheme specifies that the first uplink message or the second uplink message is to sense a channel to the central device and backoff a random amount of time before sensing again within the uplink slot based at least in part on a channel to the central device not being clear.

Aspect 9: The method of Aspect 2, wherein the indication indicates that the first peripheral device follows a contention free access scheme for an uplink channel access between the first uplink message of the first peripheral device and a second uplink message of the second peripheral device in a service period, wherein the contention free access scheme specifies that the first peripheral device is to transmit the first uplink message based at least in part on an interframe space plus a first offset or no offset and that the second peripheral device is to transmit a second uplink message based at least in part on the interframe space plus a second offset assigned to the second peripheral device.

Aspect 10: The method of Aspect 9, further comprising transmitting an offset pattern for the first offset and the second offset in a vendor-specific action frame.

Aspect 11: The method of Aspect 2, further comprising selecting an access scheme from among a scheduled access scheme, a random access scheme, and a contention free access scheme based at least in part on one or more of a quantity of connected peripheral devices or an assessment of a channel congestion level.

Aspect 12: The method of any of Aspects 1-11, wherein transmitting the indication includes transmitting the indication in a vendor-specific action frame.

Aspect 13: The method of any of Aspects 1-12, wherein the one or more first service periods are assigned to the first peripheral device in accordance with a target wake time schedule.

Aspect 14: The method of any of Aspects 1-13, wherein the one or more first service periods are configured based at least in part on a quantity of other peripheral devices that use the central device.

Aspect 15: The method of any of Aspects 1-14, wherein the one or more first service periods are configured based at least in part on a reliability parameter.

Aspect 16: The method of any of Aspects 1-15, wherein the one or more first service periods are configured based at least in part on a data sampling frequency or a refresh rate for peripheral device data.

Aspect 17: The method of any of Aspects 1-16, wherein each service period, of the one or more first service periods, supports retransmissions.

Aspect 18: The method of any of Aspects 1-17, wherein each service period, of the one or more first service periods, is based at least in part on one or more of a type of uplink data or a data rate expectation of uplink data.

Aspect 19: The method of any of Aspects 1-18, wherein the indication indicates a maximum quantity of transmission retries for the first peripheral device based at least in part on one or more of a quantity of other peripheral devices that use the central device, a modulation and coding scheme used by the central device, or a traffic pattern of data associated with the central device.

Aspect 20: A method of wireless communication performed by a first peripheral device, comprising: receiving an indication that the first peripheral device is to, within each frame rendered by a central device, receive downlink data from the central device in a downlink slot and transmit available uplink data to the central device within one or more first service periods that are assigned to the first peripheral device in an uplink slot; receiving, based at least in part on the indication, a downlink message in a downlink slot of a frame; and transmitting, based at least in part on the indication, a first uplink message in a first service period assigned to the first peripheral device in an uplink slot of the frame.

Aspect 21: The method of Aspect 20, wherein the one or more first service periods share the uplink slot with one or more second service periods assigned to a second peripheral device.

Aspect 22: The method of Aspect 21, wherein the one or more first service periods do not overlap in time with the one or more second service periods.

Aspect 23: The method of Aspect 21, wherein the one or more first service periods partially overlap in time with the one or more second service periods.

Aspect 24: The method of Aspect 21, wherein the first peripheral device shares the one or more first service periods with one or more other peripheral devices.

Aspect 25: The method of Aspect 21, wherein the indication indicates whether the first peripheral device and the second peripheral device follow a scheduled access scheme or a random access scheme for an uplink channel access between the first uplink message of the first peripheral device and a second uplink message of the second peripheral device in a service period.

Aspect 26: The method of Aspect 21, wherein the indication indicates that the first peripheral device follows a contention free access scheme for an uplink channel access between the first uplink message of the first peripheral device and a second uplink message of the second peripheral device in a service period, wherein the contention free access scheme specifies that the first peripheral device is to transmit the first uplink message based at least in part on an interframe space plus a first offset or no offset and that the second peripheral device is to transmit a second uplink message based at least in part on the interframe space plus a second offset assigned to the second peripheral device.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A central device for wireless communication, comprising:
one or more memories; and
one or more processors coupled to the one or more memories, the one or more processors individually or collectively configured to:
transmit an indication that a first peripheral device is to, within each frame rendered by the central device, receive downlink data from the central device in a downlink slot and transmit available uplink data to the central device within one or more first service periods that are assigned to the first peripheral device in an uplink slot;
transmit, based at least in part on the indication, a downlink message in a downlink slot of a frame; and
receive, based at least in part on the indication, a first uplink message in a first service period assigned to the first peripheral device in an uplink slot of the frame.

2. The central device of claim 1, wherein the one or more first service periods share the uplink slot with one or more second service periods assigned to a second peripheral device.

3. The central device of claim 2, wherein the one or more first service periods do not overlap in time with the one or more second service periods.

4. The central device of claim 2, wherein the one or more first service periods partially overlap in time with the one or more second service periods.

5. The central device of claim 2, wherein the first peripheral device shares the one or more first service periods with one or more other peripheral devices.

6. The central device of claim 2, wherein the indication indicates whether the first peripheral device and the second peripheral device follow a scheduled access scheme or a random access scheme for an uplink channel access between the first uplink message of the first peripheral device and a second uplink message of the second peripheral device in a service period.

7. The central device of claim 6, wherein the scheduled access scheme specifies that the first uplink message is to wait until a next service period of the one or more first service periods.

8. The central device of claim 6, wherein the random access scheme specifies that the first uplink message or the second uplink message is to sense a channel to the central device and backoff a random amount of time before sensing again within the uplink slot based at least in part on a channel to the central device not being clear.

9. The central device of claim 2, wherein the indication indicates that the first peripheral device follows a contention free access scheme for an uplink channel access between the first uplink message of the first peripheral device and a second uplink message of the second peripheral device in a service period, wherein the contention free access scheme specifies that the first peripheral device is to transmit the first uplink message based at least in part on an interframe space plus a first offset or no offset and that the second peripheral device is to transmit a second uplink message based at least in part on the interframe space plus a second offset assigned to the second peripheral device.

10. The central device of claim 9, wherein the one or more processors are individually or collectively configured to transmit an offset pattern for the first offset and the second offset in a vendor-specific action frame.

11. The central device of claim 2, wherein the one or more processors are individually or collectively configured to select an access scheme from among a scheduled access scheme, a random access scheme, and a contention free access scheme based at least in part on one or more of a quantity of connected peripheral devices or an assessment of a channel congestion level.

12. The central device of claim 1, wherein the one or more processors, to transmit the indication, are individually or collectively configured to transmit the indication in a vendor-specific action frame.

13. The central device of claim 1, wherein the one or more first service periods are assigned to the first peripheral device in accordance with a target wake time schedule.

14. The central device of claim 1, wherein the one or more first service periods are configured based at least in part on a quantity of other peripheral devices that use the central device.

15. The central device of claim 1, wherein the one or more first service periods are configured based at least in part on a reliability parameter.

16. The central device of claim 1, wherein the one or more first service periods are configured based at least in part on a data sampling frequency or a refresh rate for peripheral device data.

17. The central device of claim 1, wherein each service period, of the one or more first service periods, supports retransmissions.

18. The central device of claim 1, wherein each service period, of the one or more first service periods, is based at least in part on one or more of a type of uplink data or a data rate expectation of uplink data.

19. The central device of claim 1, wherein the indication indicates a maximum quantity of transmission retries for the first peripheral device based at least in part on one or more of a quantity of other peripheral devices that use the central device, a modulation and coding scheme used by the central device, or a traffic pattern of data associated with the central device.

20. A first peripheral device for wireless communication, comprising:
one or more memories; and
one or more processors coupled to the one or more memories, the one or more processors individually or collectively configured to:
receive an indication that the first peripheral device is to, within each frame rendered by a central device, receive downlink data from the central device in a downlink slot and transmit available uplink data to the central device within one or more first service periods that are assigned to the first peripheral device in an uplink slot;
receive, based at least in part on the indication, a downlink message in a downlink slot of a frame; and
transmit, based at least in part on the indication, a first uplink message in a first service period assigned to the first peripheral device in an uplink slot of the frame.

21. The first peripheral device of claim 20, wherein the one or more first service periods share the uplink slot with one or more second service periods assigned to a second peripheral device.

22. The first peripheral device of claim 21, wherein the one or more first service periods do not overlap in time with the one or more second service periods.

23. The first peripheral device of claim 21, wherein the one or more first service periods partially overlap in time with the one or more second service periods.

24. The first peripheral device of claim 21, wherein the first peripheral device shares the one or more first service periods with one or more other peripheral devices.

25. The first peripheral device of claim 21, wherein the indication indicates whether the first peripheral device and the second peripheral device follow a scheduled access scheme or a random access scheme for an uplink channel access between the first uplink message of the first peripheral device and a second uplink message of the second peripheral device in a service period.

26. The first peripheral device of claim 21, wherein the indication indicates that the first peripheral device follows a contention free access scheme for an uplink channel access between the first uplink message of the first peripheral device and a second uplink message of the second peripheral device in a service period, wherein the contention free access scheme specifies that the first peripheral device is to transmit the first uplink message based at least in part on an interframe space plus a first offset or no offset and that the second peripheral device is to transmit a second uplink message based at least in part on the interframe space plus a second offset assigned to the second peripheral device.

27. A method of wireless communication performed by a central device, comprising:
transmitting an indication that a first peripheral device is to, within each frame rendered by the central device, receive downlink data from the central device in a downlink slot and transmit available uplink data to the central device within one or more first service periods that are assigned to the first peripheral device in an uplink slot;
transmitting, based at least in part on the indication, a downlink message in a downlink slot of a frame; and
receiving, based at least in part on the indication, a first uplink message in a first service period assigned to the first peripheral device in an uplink slot of the frame.

28. The method of claim 27, further comprising selecting an access scheme from among a scheduled access scheme, a random access scheme, and a contention free access scheme based at least in part on one or more of a quantity of connected peripheral devices or an assessment of a channel congestion level.

29. A method of wireless communication performed by a first peripheral device, comprising:
receiving an indication that the first peripheral device is to, within each frame rendered by a central device, receive downlink data from the central device in a downlink slot and transmit available uplink data to the central device within one or more first service periods that are assigned to the first peripheral device in an uplink slot;
receiving, based at least in part on the indication, a downlink message in a downlink slot of a frame; and
transmitting, based at least in part on the indication, a first uplink message in a first service period assigned to the first peripheral device in an uplink slot of the frame.

30. The method of claim 29, wherein the indication indicates that the first peripheral device follows a contention free access scheme for an uplink channel access between the first uplink message of the first peripheral device and a second uplink message of the second peripheral device in a service period, wherein the contention free access scheme specifies that the first peripheral device is to transmit the first uplink message based at least in part on an interframe space plus a first offset or no offset and that the second peripheral device is to transmit a second uplink message based at least in part on the interframe space plus a second offset assigned to the second peripheral device.
